(19) United States
(12) Patent Application Publication
(10) Pub. No.: US 2004/0162737 A1
(43) Pub. Date: Aug. 19, 2004

(54) Agreement management system

(75) Inventors: Sekio Ikeda, Kawasaki (JP); Tadao Asamizu, Kawasaki (JP); Isao Ohide, Kawasaki (JP); Aki Nagano, Kawasaki (JP); Naoko Sato, Kawasaki (JP); Kenji Matoba, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/773,237

(22) Filed: Feb. 9, 2004

(30) Foreign Application Priority Data
Feb. 7, 2003 (JP) 2003-031687

(51) Int. Cl. G06F 17/60

(52) U.S. Cl. 705/1

(57) ABSTRACT

When an agreement such as a patent agreement, etc. is concluded between companies, contents of the agreement are registered to an agreement contents database. If a money balance occurs in accompaniment with the agreement, balance data is associated with data of the contents of the agreement, and registered to a balance database. A document relevant to the agreement, such as a memorandum of understanding, etc. is put into image data, and stored in an agreement relevant document database. A user can view the contents of the agreement contents database, the balance database, and the agreement relevant document database within the scope of an access right, if he or she is permitted to use the system. Additionally, since agreements are managed in a centralized manner, achievements such as a balance of an entire company, a balance of each division, etc., which accompany an agreement, can be easily calculated as statistical data.

### BACKGROUND OF THE INVENTION

1. Field of the Invention

The present invention relates to an agreement management system assisting in agreement operations.

2. Description of the Related Art

For contracts or agreements such as a patent agreement, a know-how agreement, a joint development agreement, etc., parties (companies, or an individual and a company) exchange written agreements. At the time of the agreement, the scope of a license, consideration conditions, etc. are mutually arranged. Agreement management is usually made by various divisions such as a division responsible for an agreement (division that negotiates the agreement), a division managing a right, an accounting division handing a balance, etc. Furthermore, management of an agreement is made in various forms. For example, a division responsible for an agreement may vary by an agreement type, and a division managing an agreement (agreement management division) differs from a division storing a written agreement (an agreement storing division).

If the number of agreements is small, and if one division collectively manages agreements, accesses to the written agreements, etc. can be made with relative ease on demand. However, if the number of agreements is considerably large, and if divisions that handle the agreements are mutually independent, the following problems occur.

A division in charge of an agreement is burdened with the responsibility of holding documents relevant to the agreement. Accordingly, documents relevant to agreements spread over respective divisions. Therefore, it takes time to find out what agreements exist as a whole. Additionally, for example, when negotiation is newly made with a certain company, an examination must be made across divisions to grasp the past agreement relationships, which forces troublesome operations.

As described above, divisions to which managed agreements are relevant are diverse. Examples of such divisions include a management source of a right, which is the base of an agreement, a division in charge of negotiation, a division managing a balance, a division issuing a bill (accounting division, etc.), etc. Predetermined procedures (a request for a managerial decision, etc.) are essential to conclude an agreement depending on a company. Therefore, documents which occur in accompaniment with an agreement must be managed.

Additionally, since agreement contents, etc. are stored on a paper basis, an access must be made to each agreement file in order to learn about terms and conditions (licensing conditions or consideration conditions, restriction articles, etc.) of each agreement. Especially, difficulties exist in attempts to grasp the past income or payments based on an agreement relevant to an intellectual property right of a patent, etc. (although rights to be treated with agreements of a patent, a utility model, a design, a trademark, or the like are diverse, rights to be permitted, transferred, etc. as intellectual property rights are generically called “patent” unless otherwise noted. Additionally, although “a right is permitted” or “a right is transferred” depending on an agreement, “permit” is generically used including the meaning of “transfer” in some cases where a distinction is not required, unless otherwise noted).

Referred to as “patent accounting”, etc., attention has been paid to a relationship between a balance relevant to intellectual property rights and settlement of balance (balance sheet, etc.) of an entire company in recent years, so that a balance relevant to intellectual property rights must be reflected on the profitability of an entire company. However, the above described way of managing each agreement causes an inconvenience in actually including the balance relevant to intellectual property rights in the settlement of balance of the entire company.

Additionally, the income or payment of a license fee under an agreement is sometimes distributed or shared to a company other than agreement parties. Also management of an income earned by such an agreement type is not easy. For example, if an agreement is made as a representative with another company for a joint right, part of an income earned by that agreement is distributed to a joint partner, or also a payment is similarly shared in some cases.

In the meantime, a similar problem occurs within a company. If a license income, etc. is earned for a right managed across divisions within the company, the income must be distributed to the divisions. Additionally, a payment (expenditure) must be shared by divisions. Such a distribution or sharing among divisions within a company cannot be easily managed if documents relevant to an agreement spread and are held by individual divisions.

Furthermore, there may be cases where contents of an agreement are changed by exchanging a memorandum of understanding after the agreement is concluded. Also a memorandum of understanding is an agreement which accompanies the original agreement if the memorandum of understanding is exchanged (corresponding to an addition of an agreement condition) due to an addition of a licensed product or a license, etc. after the agreement is concluded. Therefore, the memorandum of understanding must be managed in association with the original agreement. However, this handling is also troublesome.

The phenomenon that the current agreement state cannot be easily grasped causes an inconvenience in determining a policy of license activities, and in creating basic materials, which can possibly prevent an effective policy decision.

Accordingly, it is desirable that written agreements, etc. are collectively managed within a company. However, managing all of written agreements, etc. also encounters technical difficulties. This is because divisions involved in the written agreements are diverse, and the number of agreements becomes large.

In the meantime, for a written agreement, a heavy restriction such as confidentiality, etc. is imposed in terms of management, and security is important. Accordingly, since collectively managing written documents, etc. is risky, the collective management was not made also in terms of security on which importance is placed.

Conventionally, however, attempts were made to efficiently manage agreements.

Patent Document 1 discloses a technique for managing an agreement term, for calculating the termination date of the agreement term, and for presenting to a user an agreement the termination date of which is close. Patent Document 2 discloses a technique for managing legal operations, with which agreement negotiation request information and agreement request details information are extracted from a database, the extracted information is combined with information from a business division to create and record concluded agreement information, an agreement term is managed, and a notification is made to a responsible person when the agreement expiry date approaches. Patent Document 3 discloses a configuration where confidentiality is maintained in data management. Also Patent Document 4 discloses a technique related to confidentiality in a database system, which determines whether or not to permit an access to data depending on a division in an organization, a job title, etc. Also Patent Document 5 discloses a technique for restricting an access to document data, and for permitting an access to a document according to a use right.

[Patent Document 1]

Japanese Patent Application Publication No. 2001-117998

[Patent Document 2]

Japanese Patent Application Publication No. 2001-216407

[Patent Document 3]

Japanese Patent Application Publication No. HEI9-6681

[Patent Document 4]

Japanese Patent Application Publication No. 2000-20377,

[Patent Document 5]

Japanese Patent Application Publication No. 2001-142874

Conventionally, a proposal to electronify a written agreement format, etc., and to automatically create a written agreement form is made. Especially, this is applied to an insurance agreement, a credit card agreement by mail order, etc.

Besides, conventionally, even if an agreement management system exists, the number of types of agreement is large, and management of an income/expenditure accompanying an agreement is complicated. Therefore, an effective and functional use of agreement data has not yet been considered yet although attempts to electronically manage an agreement have been made instead of writing it down as an agreement list.

### SUMMARY OF THE INVENTION

An object of the present invention is to provide a system assisting in agreement management with which data such as a patent agreement, etc. can be effectively and functionally used.

The system according to the present invention comprises: an agreement database to which at least basic information, an agreement target, and agreement conditions among information about an agreement are registered; a balance database to which a running royalty and balance information, which are relevant to the agreement, are registered; and an operating unit performing an operation such as registration, modification, reference, search, inquiry, display or printing for the data relevant to the agreement registered to the balance database.

According to the present invention, data obtained relevantly to an agreement are collectively managed, and can be used effectively and functionally on demand, leading to an increase in the efficiency of operations of a division that handles a number of agreements, such as patent operations, etc. Besides, the larger an organization that introduces the system according to the present invention, the easier the obtainment of a balance, etc. of agreements within an entire company. This simplifies information exchange of agreement relationships within the entire company.

### BRIEF DESCRIPTION OF THE DRAWINGS

FIG. 1 exemplifies the configuration of a system to which a preferred embodiment according to the present invention is applied;

FIG. 2 shows the configuration of functions of the system according to the preferred embodiment of the present invention;

FIG. 3 shows the relationship among data in a database;

FIG. 4 exemplifies the data structure of a master database;

FIG. 5 is a schematic (conceptual schematic No. 1) exemplifying a data structure of a database for managing agreements, which is extended in a memory, in the system according to the preferred embodiment of the present invention;

FIG. 6 is a schematic (conceptual schematic No. 2) exemplifying a data structure of the database for managing agreements, which is extended in the memory, in the system according to the preferred embodiment of the present invention;

FIG. 7 shows a transition (No. 1) of a display made on a display unit of the system according to the preferred embodiment of the present invention;

FIG. 8 shows a transition (No. 2) of the display made on the display unit of the system according to the preferred embodiment of the present invention;

FIG. 9 shows a transition (No. 3) of the display made on the display unit of the system according to the preferred embodiment of the present invention;

FIG. 10 shows a transition (No. 4) of the display made on the display unit of the system according to the preferred embodiment of the present invention;

FIG. 11 shows the classification of agreement party relationships;

FIG. 12 exemplifies the configuration of a registration/modification screen;

FIG. 13 exemplifies an agreement basic information (bibliographical items) registration screen;

FIG. 14 exemplifies an input screen of other agreement conditions;

FIG. 15 shows a configuration example of each screen (for search) (No. 1);

FIG. 16 shows a configuration example of each screen (for search) (No. 2);

FIG. 17 shows a configuration example of each screen (for search) (No. 3);

FIG. 18 shows a configuration example of each screen (for search) (No. 4);

FIG. 19 shows a configuration example of each screen (for search) (No. 5);

FIG. 20 shows a configuration example of each screen (for search) (No. 6);

FIG. 21 exemplifies an agreement list display resultant from a search;

FIG. 22 exemplifies an agreement original (for example, a summary of the agreement) display;

FIG. 23 explains the downloading of agreement data in a CSV format and its display (No. 1);

FIG. 24 explains the downloading of agreement data in a CSV format and its display (No. 2);

FIG. 25 exemplifies the configuration of a balance data screen (registration/modification);

FIG. 26 exemplifies an input screen of a deposit;

FIG. 27 exemplifies an input screen of installments such as a deposit, etc.;

FIG. 28 exemplifies a royalty balance input screen;

FIG. 29 exemplifies an other balance input screen;

FIG. 30 exemplifies an implementation report (such as royalty report) state inquiry screen;

FIG. 31 exemplifies an implementation report (such as royalty report) state search result screen;

FIG. 32 explains access rights (No. 1);

FIG. 33 explains access rights (No. 2);

FIG. 34 explains access rights (No. 3);

FIG. 35 explains access rights (No. 4);

FIG. 36 explains an access right (No. 5);

FIG. 37 explains an access right (No. 6);

FIG. 38 exemplifies a screen relevant to statistical data (No. 1);

FIG. 39 exemplifies a screen relevant to statistical data (No. 2);

FIGS. 40A through 40C exemplify a screen relevant to statistical data (No. 3);

FIG. 41 exemplifies a screen relevant to statistical data (No. 4);

FIG. 42 exemplifies a screen relevant to statistical data (No. 5);

FIG. 43 is a flowchart showing a registration/modification/reedition process starting from login;

FIG. 44 is a flowchart showing a subnumber process;

FIG. 45 is a flowchart showing a process for registering basic information;

FIG. 46 is a flowchart showing a process for registering data of an agreement target;

FIG. 47 is a flowchart showing a process for setting other agreement conditions;

FIG. 48 is a flowchart showing a process for setting a consideration condition;

FIG. 49 is a flowchart showing a process for inputting relevant information;

FIG. 50 is a flowchart showing a process for registering an electronically stored document;

FIG. 51 is a flowchart showing a process for registering balance data;

FIG. 52 is a flowchart showing a process for registering other balance information;

FIG. 53 is a flowchart showing a search/inquiry process;

FIG. 54 is a flowchart showing an alarm process:

FIG. 55 is a flowchart showing an alarm process for the receipt of an implementation report (such as royalty report);

FIG. 56 is a flowchart showing an alarm process for the submission of an implementation report (such as royalty report);

FIG. 57 is a flowchart showing an alarm process for installments; and

FIG. 58 is a flowchart showing a statistical data process.

### DESCRIPTION OF THE PREFERRED EMBODIMENTS

To collectively manage agreement data, adequate security is required. Agreement data itself is naturally stored by being encrypted. Additionally, for agreement data, which cannot be disclosed among divisions, an access to the data, which is made across divisions, must be prohibited. Furthermore, to enable agreement data to be used effectively and functionally, balance data of a particular agreement must be easily obtained, and a balance accompanying agreements as an entire company must be easily grasped.

To overcome the above described issues, the following measures are required.

Enabling necessary agreement data to be easily searched.

Enabling the scope of disclosure, an agreement to be disclosed, etc. to be selected with an access restriction in the search.

Facilitating the management of materials (documents) accompanying an agreement along with its written agreement, because base materials prior to an agreement, agreement negotiation materials, materials after the agreement is concluded, etc. amass a huge volume.

Also enabling the management of a change or an addition made to agreement contents with a memorandum of understanding.

Enabling an agreement with the same company to be easily searched even if a change is made to a company name or the like.

Enabling measures to be easily taken even if a division name or a division is abolished or merged, or transferred to a new division, etc.

Enabling an agreement expiry date, especially, the renewal or the automatic termination of an agreement to be coped with.

Enabling installments in accordance with an agreement to be coped with.

Enabling a deadline to be managed, because an implementation report (such as royalty report), etc. in accordance with an agreement is mandatory.

Enabling control to be performed in order to prevent data from overflowing due to a large number of items when downloading the data with an existing application, because necessary items (the number of items) in an agreement becomes very large, and an output of the data becomes a problem in the case where the agreement is put into a database.

To implement the above described measures, the following functions are provided according to a preferred embodiment of the present invention.

Management of an agreement is based on a target right and a consideration.

Clarifying a target right.

Enabling data such as the scope of a right, etc. to be registered for each right.

Managing both of an income and expenditure as considerations.

Managing an income and expenditure (payment) if considerations are mutually exchanged between parties in one agreement.

Managing incomes from a plurality of counterparts among a plurality of parties.

Managing the case where a payment is incurred to a plurality of counterparts among a plurality of parties.

Managing an agreement by regarding each payment or each income of a consideration as an individual agreement, for one agreement which incurs a plurality of incomes/payments (one agreement is virtually regarded as a plurality of agreements, and registered).

There are two types of management methods as this technique: a method independently taking a management number, and a method generating and adding a subnumber.

Managing the distribution/sharing of a consideration.

Managing the distribution/sharing made by relevant divisions within a company.

Managing the distribution/sharing among parties relevant to an agreement other than parties concluding the agreement.

Enabling an access right to be given for each data block.

Grouping access rights for each division.

Enabling a division responsible for an agreement to view agreement data, even if an access made from a person outside the division is prohibited for the agreement data of a different division.

Performing control for contents of each agreement with an access right, although the existence of an agreement as an agreement list can be viewed by everybody. Also performing control such that part of an agreement list, such as a summary (title, etc.), etc., which is relevant to agreement contents, is not to be permitted to be viewed.

Enabling an agreement party relationship to be clearly grasped (displayed on a screen).

Enabling many agreement items to be briefly viewed (an agreement original display on a screen).

Enabling a right relationship among a plurality of parties to be grasped (supported with subnumbers).

Classifying data inputs made by a plurality of parties into a common item and an individual item in order to reduce the operations of condition inputs, and executing a copy process for the common item (especially, in a subnumber process).

Also enabling a common item for which the copy process is executed to be modified/changed.

Enabling data to be output by adding an item regardless of the number of items to put the data into a block in a data output.

Enabling the state of a target right in an agreement to be updated.

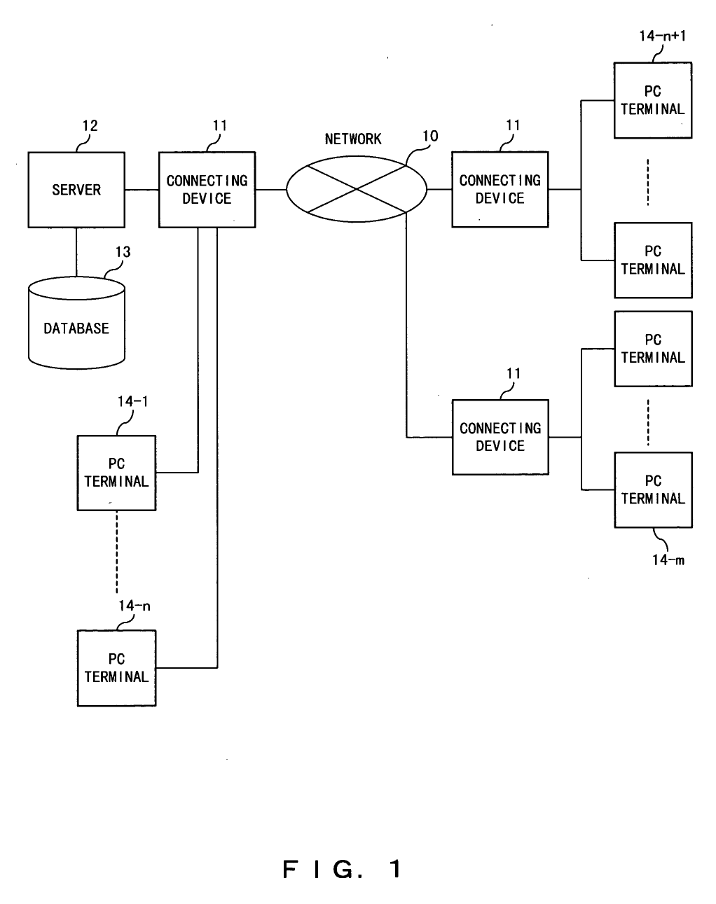

FIG. 1 exemplifies the configuration of a system to which the preferred embodiment according to the present invention is applied. A database 13 is a storage medium storing agreement information. A server 12 stores agreement information in the database, and manages the information. PC terminals 14-1 to 14-n, and 14-n+1 to 14-m are a plurality of user side terminals (user terminals), such as personal computers, for registering, searching, and referencing agreement information. In the preferred embodiment, the user terminals 14-1 to 14-n are connected to the server 12 via a connecting device 11, so that they can access the database. The user terminals 14-n+1 to 14-m, and the server 12 are connected via a connecting device 11 and a network 10.

According to the present invention, use forms such as a form where the server 12 and the user terminals 14-1 to 14-m are located in the same site (in the same building, etc.), or a form where the server 12 and the user terminals 14-1 to 14-m are connected via a network (the Internet/intranet, etc., a company-wide LAN, a network via a communications line, etc.) may be implemented. A connection form of the server 12 and the user terminals 14-1 to 14-m is not particularly limited.

Usage of the terms “register” and “modify” is as follows. Since the term “modify” means that registered data is changed (modified) and the data is again registered, “modify” also includes the meaning of re-registration”. Accordingly, “register” is generically used as a technical meaning, and sometimes includes the meaning of “modify” unless a distinction is required.

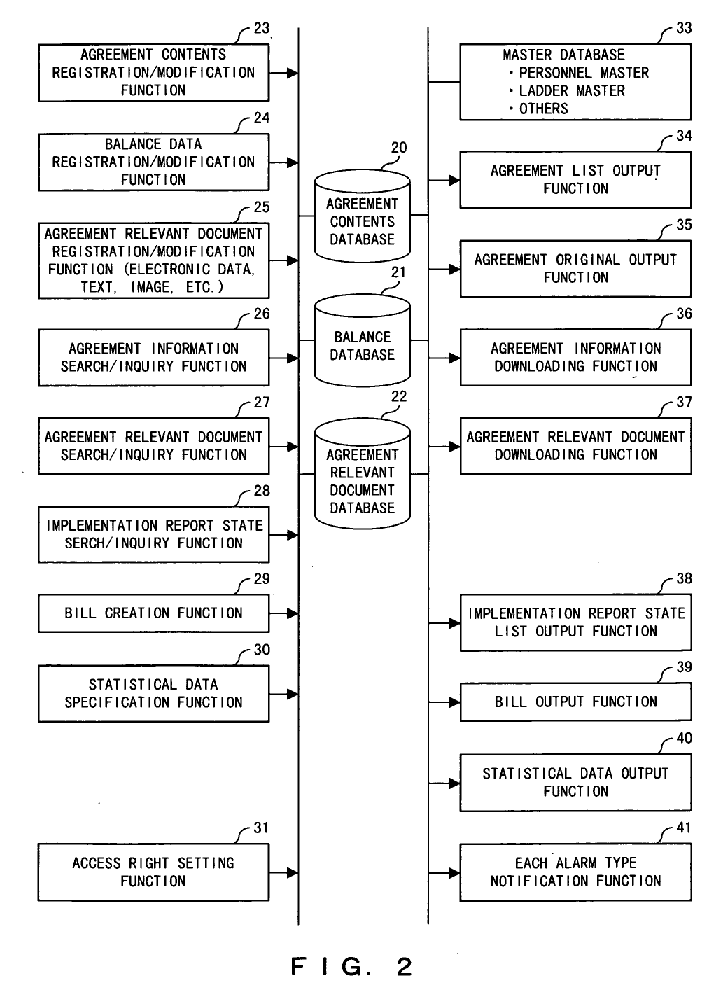

FIG. 2 shows the configuration of functions of the system according to the preferred embodiment of the present invention.

An agreement contents database 20 storing information such as agreement parties, an agreement form, agreement conditions, etc. as agreement information, a balance database 21 storing data (balance data) relevant to a balance such as a deposit, a royalty, etc., which is incurred after the agreement is concluded, and an agreement relevant document database 22 storing documents such as a written agreement, an implementation report (such as royalty report) occurring in accompaniment with the agreement, a bill or the like, negotiation materials for reaching an agreement, negotiation minutes, etc. are provided. These databases may be configured physically as one database, or as separate databases.

An agreement contents registration/modification function 23 is a function (man-machine interface) for making a user register or modify contents of an agreement, and is used to register contents of an agreement to the agreement contents database 20, or to modify contents of a registered agreement. A balance data registration/modification function 24 is a function (man-machine interface) for making a user register or modify balance data, and is used to register balance data to the balance database 21, or to modify balance data.

An agreement relevant document registration/modification function 25 (for electronic data, text, image data, etc.) is a function (man-machine interface) with which a user registers the above described documents relevant to an agreement to be electronically stored, or modifies a registered document (including a deletion, etc. of a document which becomes unnecessary), and is used to register document data to the agreement relevant document database 22, or to modify registered document data.

An agreement information search/inquiry function 26 is a function for searching or inquiring about contents of an agreement stored in the agreement contents database 20. An agreement information downloading function 36 (for example, downloading of data in a CSV format) is a function for downloading electronically stored agreement data, which is searched or inquired by the agreement information search/inquiry function 26 and stored in the agreement contents database 20 and the balance database 21, as it is.

An agreement relevant document search/inquiry function 27 is a function for searching/inquiring about an agreement relevant document stored in the agreement relevant document database 22. An agreement relevant document downloading function 37 is a function for downloading data of an agreement relevant document searched or inquired by the agreement relevant document search/inquiry function 27.

An implementation report (such as royalty report) state search/inquiry function 28 is a function for searching the data stored in the agreement contents database 20, the balance database 21, and the agreement relevant document database 22 for the current implementation state of an agreement, the payment state of a running royalty, etc. An implementation report (such as royalty report) state list output function 38 is a function for displaying on the display unit or printing a list of implementation states searched or inquired by the implementation report (such as royalty report) state search/inquiry function 28. Note that some agreements can possibly have no obligation to report their implementation state, and others can possibly make an arrangement to abort or resume an implementation report (such as royalty report) depending on an implementation state. Accordingly, for the above described registration of agreement contents data, when there is no implementation report (such as royalty report) although an arrangement of a running royalty, etc. is made as a consideration condition, or when an implementation report (such as royalty report) is aborted to be made, resumed, etc., during the implementation of the agreement, data such as unsubmission, abortion, resume, etc. of an implementation report (such as royalty report) is registered depending on the implementation state of agreement contents, whereby agreements whose implementation report (such as royalty report) s are not made can be also excluded from an implementation state list to be output.

A bill creation function 29 is a function for creating a bill according to an implementation state when a company on this side requests a payment to an agreement counterpart. The created bill is printed with a bill output function 39.

A statistical data specification function 30 is a function for specifying, for the system, which type of statistical data is to be obtained when acquiring statistical data of a balance in accordance with an agreement, such as balance data of each agreement in an entire company, balance data of each agreement in each division, etc. A statistical data output function 40 is a function for displaying or printing statistical data based on the target data to be specified by the statistical data specification function 30.

An access right setting function 31 is a function for setting an access right to the data stored in the agreement contents database 20, the balance database 21, and the agreement relevant document database 22.

An agreement list output function 34 is a function for displaying and printing, as a list, predetermined items among agreement contents stored in the agreement contents database 20. An agreement original (for example, a summary of the agreement) output function 35 is a function for displaying and printing details of contents of each agreement specified by search or inquiry among agreement contents data and balance data, which are stored in the agreement contents database 20 and the balance database 21.

An alarm type notification function 41 is a function for notifying a responsible person that an expiry date or a deadline is close in the case where a term of a particular agreement is about to expire, or its implementation report (such as royalty report) deadline is about to come.

A master database 33 stores data such as division information (ladder master) used at the time of login to the system, registration of agreement data, etc., access right giving or checking (personnel master), identification data of a country, party data (company code, company name, etc.), and the like at the time of data registration.

Also the master database 33 is described as a database separate from the databases such as the agreement contents database 20, and the like. However, these databases may be physically one or a plurality of databases, and their configurations are not particularly limited.

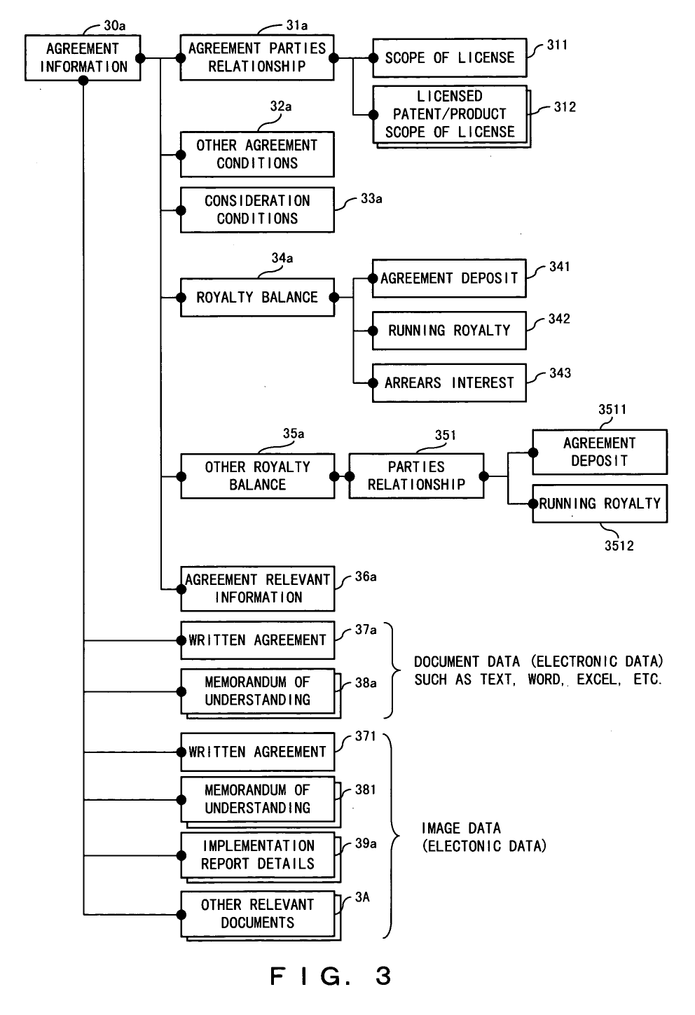

FIG. 3 shows the relationship among data in a database.

Conventionally, building a unified database was considered to be difficult. The reason that management of agreement information is difficult and cannot be configured as a system is as follows: documents of an agreement and data of agreement conditions, etc. may vary depending on the type of an agreement, and construction of a unified database was considered to be difficult. The present invention solves this problem by devising the structure of data as a configuration of an agreement information database.

Attention is focused on agreement information, which is composed of agreement contents data indicating contents of an agreement, balance data accompanying the agreement, and documents relevant to the agreement, and the relationship among these items of data is built in a database as shown in FIG. 3.

Documents relevant to an agreement among agreement information 30a include a written agreement 37a and a memorandum of understanding 38a, which are composed of document data (electronic data) such as text data, Word (trademark) data, Excel (trademark) data, etc., and a written agreement 371, a memorandum of understanding 381, details of an implementation report (such as royalty report) 39a, and other relevant documents 3A, which are composed of image data (electronic data). These data items are merely examples, and do not limit the format or the type of a document. An agreement negotiation progress table, minutes, etc. in a text format may be stored depending on need.

Additionally, agreement contents data of the agreement information include an agreement parties relationship 31a which indicates parties concluding an agreement, the scope of a license 311 as an agreement condition, the scope of a licensed patent/product 312, other agreement conditions 32a arranged by the agreement, consideration conditions 33a such as a deposit, a running royalty, etc., agreement relevant information 36a such as an attorney's fee accompanying the agreement, etc.

Balance data of the agreement information include a royalty balance 34a as management data of the presence/absence of a payment/income of a deposit or a running royalty, and other royalty balance 35a indicating the distribution, sharing, etc. to a joint applicant other than agreement parties, or a compensation payment, etc., in addition to a normal royalty. The royalty balance 34a includes, as a classification of the royalty balance, an agreement deposit 341 (sometimes includes a past royalty or an advance committed to the future royalty, a transfer expense, etc. incurred when a right is transferred, in addition to a deposit as an agreement commission, etc.), a running royalty stipulated as a specific amount of money, and an arrears interest prescribed by a consideration condition. The other royalty balance 35a includes a parties relationship 351 stipulating a balance relationship other than agreement parties, an agreement deposit 3511, a running royalty 3512, etc.

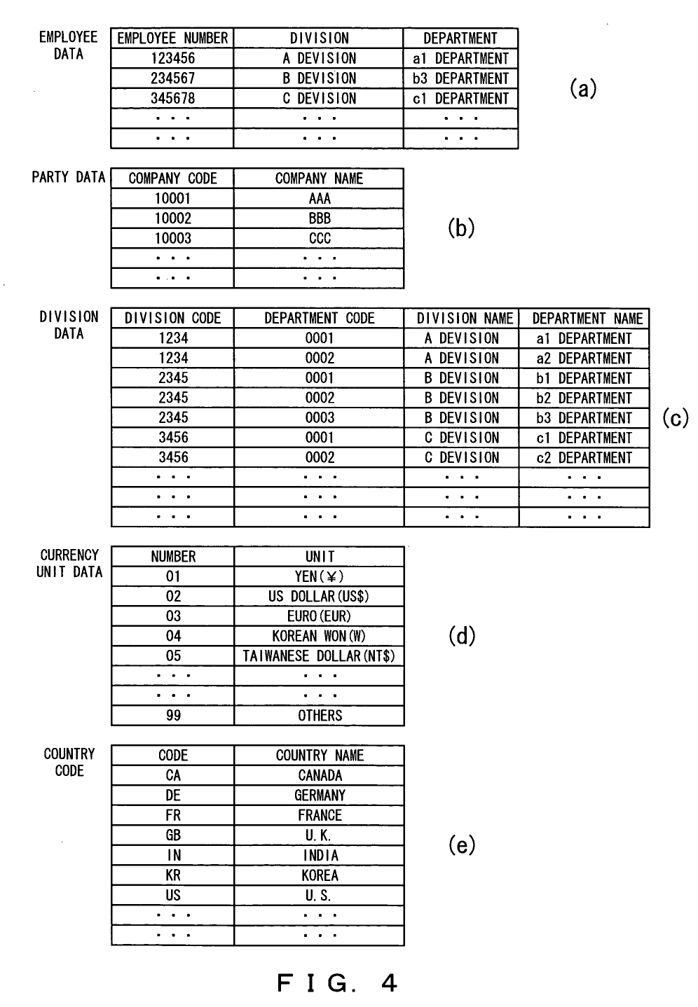

FIG. 4 exemplifies the data structure of the master database.

Employee data shown in FIG. 4A is used to verify an employee and his or her division when an access right is given to the employee (user) who uses the system according to the preferred embodiment of the present invention, and to verify an employee when he or she inputs each agreement data.

As agreement party data shown in FIG. 4B, a company code and a company name are registered. A company name can be input as the registration of agreement data.

As agreement party data shown in FIG. 4B, a company code and a company name are registered. As a registration of agreement data, not only a company name can be directly input, but also a company code can be input.

For a company name, there are various cases such as a case where a common or abbreviated name is used, a case where, for example, “stock company” precedes or succeeds a company name, a case where “stock company” is abbreviated to “Co. Ltd.” or spelled out, and the like. Accordingly, if agreement data is input according to a user's liking, who registers agreement data, company name data is not uniform in notation, which is inconvenient to a data search. To avoid this problem, a method inputting a company name may be regularized. In this preferred embodiment according to the present invention, all of inputs are made with a company code, and master data that makes a correspondence between a company code and a company name is comprised. This registration method using a company code can unify data irrespective of users, and can easily cope with a case where a company name is changed. Also an input error of a user who registers data can be prevented.

A target company code used when a user registers or searches agreement data is obtained by indexing this database.

In division data shown in FIG. 4C, a division code, a subordinate department code, a division (name), and a department name are registered in correspondence. An advantage that a division code and a department code are used instead of a division name and a department name when agreement data is registered is similar to that in the case of party data. If a department code does not exist, only a division code can be input. Or, a change can be appropriately made. For example, a section code is provided subordinately to a department code. As currency unit data shown in FIG. 4D, currency unit codes and unit names are registered. This data is referenced to decide the unit of a money amount when a consideration condition or data of a royalty balance is input. With this data, for example, any of a case where a royalty is decided to be paid in yen when an enterprise in a foreign country and an enterprise in Japan conclude an agreement, and a case where a royalty is decided to be paid in a currency unit of a foreign country can be coped with.

Country codes shown in FIG. 4E are referenced when a country name of an agreement party is specified and registered.

When an agreement list or an agreement original (for example, a summary of the agreement) is output, an abbreviation (code) of a country is displayed along with a party name (company name) by the system.

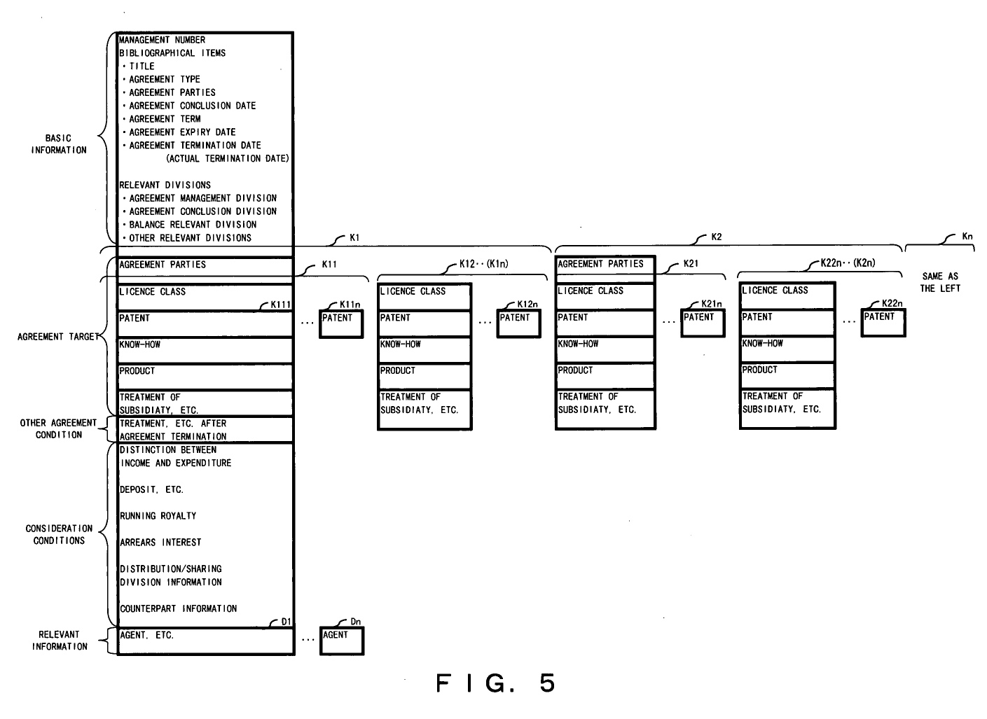

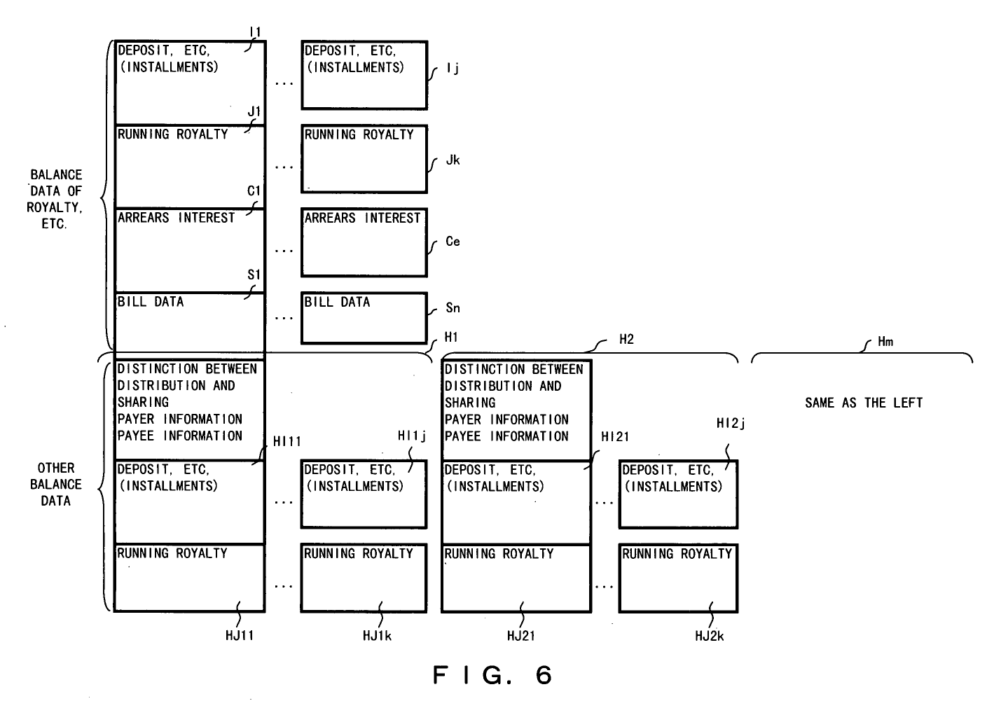

FIGS. 5 and 6 are schematics (conceptual schematics) exemplifying a data structure of the database for managing agreements, which is extended in the memory, in the system according to the preferred embodiment of the present invention.

As shown in FIG. 5, information of one agreement is stored under one management number. As basic information, an agreement type, agreement parties, an agreement conclusion date, an agreement term, an agreement expiry date, and an agreement termination date (actual termination date) are registered as bibliographical items in addition to a management number. Also divisions involved in the agreement managed with the management number are registered. Registered divisions are an agreement management division, an agreement conclusion division, a balance relevant division, and other relevant divisions. A division may be added depending on need. Agreement target items stipulate a specific right permitting/permitted by an agreement, and are configured by agreement parties (data indicating from whom to whom), a license class (normal license, exclusive license, etc.), patent (including number specification, package licensing, etc.), know-how, product, treatment of a subsidiary, etc. The target agreement items are organized by an agreement party, and provided for each agreement party. K1, K2, . . . Kn of FIG. 5 indicate that right information, etc. as agreement targets among n different agreement parties are/can be independently registered in an agreement stipulated based on basic information. Additionally, the right information for each of the agreement parties K1, K2, . . . Kn can be individually registered as license classes K11, K2, . . . , K1n, K21, K22, . . . K2n. Furthermore, since a plurality of patents, know-how, and products can possibly exist for each of the license classes K1, . . . , these are allowed to be set. The example of FIG. 5 shows that a plurality of patents K111 to K11n are/can be registered for a patent. Also a plurality of patents K121 to K12n in a license class K12 . . . , a plurality of patents K211 to K21n in a license class K21 . . . , and a plurality of patents K221 to K22n in a license class K22 . . . are similar, and the respective license classes identify all of patents permitted to be used by one license agreement. This is similar for know-how and products.

With such a configuration, with one agreement, rights of both parties when a plurality of agreement parties (not limited to two companies) mutually grant licenses, or all of rights the license classes of which are different can be registered.

For an agreement identified with the basic information, other agreement conditions are provided, and a portion which records a treatment after agreement termination is provided.

Additionally, also consideration conditions in an agreement are recorded as important items of agreement data. As the consideration conditions, a distinction between income and expenditure, a deposit, etc., a running royalty, an arrears interest, distribution/sharing division information, and counterpart information are registered. If consideration conditions (including mutual payments) are set among a plurality of parties in one agreement, exactly the same consideration conditions are rarely stipulated. Accordingly, for example, 6 types of consideration conditions can be possibly stipulated in an agreement concluded among 3 companies as the consideration conditions registration among the parties. This is also one of conventional reasons that make it difficult to put agreement data into a database, and to manage the data. The present invention focuses attention on the flow of a balance (stipulated by a consideration condition) among agreement parties, and implements a configuration with an idea that only one consideration condition is allowed to be registered with one agreement management number. For example, if an agreement has a form where consideration payments are mutually incurred between two companies, this agreement is put into a database by being recognized as two virtual agreements such as (1) an agreement of a consideration payment, and (2) an agreement of a consideration income. How to handle these virtual agreements will be described later. Accordingly, the consideration conditions shown in FIG. 5 mean consideration conditions presented from a company A to a company B if the agreement parties in the upper portion of this figure indicate the license granted from the company A to the company B. In this case, the royalty balance of the consideration payment to be described next is payment data from the company B to the company A. Here, if a consideration condition from the company B to the company A exists, there are two methods in the present invention: a method virtually regarding the consideration condition as an independent agreement and assigning another management number, and a method adding a subnumber of a management number and registering data as a virtual agreement for each subnumber. This will be described later.

As relevant information of an agreement at the bottom of FIG. 5, an agent, etc. are recorded. A plurality of agents, etc. can be recorded. If an agreement is concluded with a plurality of agents, information of these agents D1 to Dn are recorded as the relevant information. As the agent information, not only a lawyer, a patent attorney, etc, who is involved in the agreement, but also expense information (a consultation fee, lawsuit cost, etc.) can be registered. The expense information can be reflected on statistical balance data of an agreement. For example, a process for subtracting a lawsuit cost from the income earned by the agreement can be executed. Accordingly, as statistical data of a royalty balance, more accurate data can be also obtained.

FIG. 6 shows the structure of balance data in an agreement identified with basic information. As balance data of a royalty, etc., a deposit, etc., a running royalty, an arrears interest, bill data (for issuing a bill), etc. are provided. Installments are respectively applicable to these items. The deposit, etc. can be a deposit payment after an agreement, such as a deposit at the time of product shipment, etc. in addition to a deposit payment when an agreement is concluded. Also the royalty payment is incurred a plurality of times, such as a payment for every half year or for every quarter. The arrears interest and bill data are similar. Accordingly, deposits I1 to Ij indicate a payment of a deposit, etc. made by j times including a case of installments. Similarly, the royalty is paid by k times as indicated by J1 to Jk, and the arrears interest is paid by l times as indicated by C1 to Cl. For the bill data, its issuance made by n times is recorded as indicated by S1 to Sn. In these data, data required for managing the agreement, such as a payment due date, an implementation report (such as royalty report) receipt date, etc. in addition to a payment amount can be recorded, although these are not shown (the term “payment” is defined below. If a payment from a company A to a company X, and a payment from the company X to the company A are incurred, two events such as a payment and an income exist when viewed from the company A. Hereinafter, the term “payment” also includes the meaning of “income” if the direction does not need to be defined).

Additionally, as balance data in an agreement identified with basic information, other balance data is recorded. The other balance data is managed by being separated into groups H1 to Hn, which are identified with a distinction between distribution and sharing, payer information, and payee information. In each of the groups, a deposit, etc., and a running royalty are recorded also in consideration of installations. For the deposit, etc., distribution or sharing made by j times HI11 to HI1j, and payment distribution or sharing made by 2j times HI21 to HI2j are indicated. Also for the royalty, distribution or sharing made by 1k times HJ11 to HJ1k, and distribution or sharing made by 2k times HJ21 to HJ2k are indicated.

The data structures shown in FIGS. 5 and 6 are represented as relational databases. However, they may be in a transaction form or other forms.

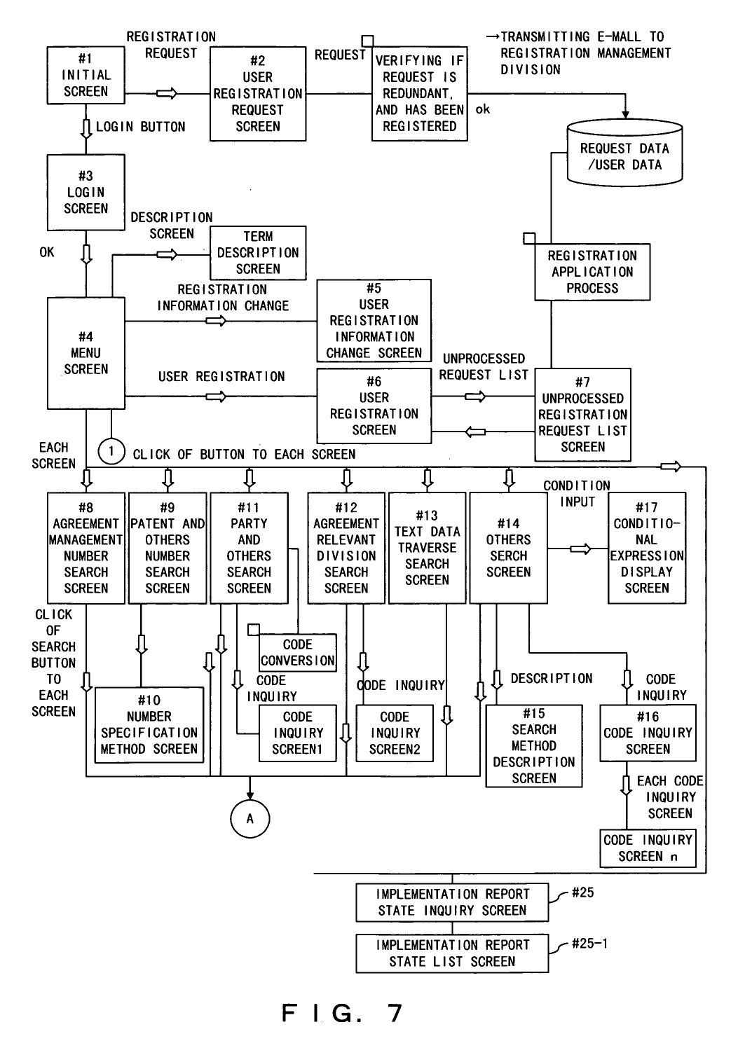

FIGS. 7 to 10 are schematics showing transitions of a display made on the display unit of the system according to the preferred embodiment of the present invention.

The display starts from an initial screen #1 of FIG. 7. When a user makes registration, the display proceeds to a user registration request screen #2. The user who desires to register himself inputs necessary information on the user registration request screen #2 to make a request. The system verifies if this request is redundant, or if the user has been registered. If the system accepts the registration request, it stores the request data and the user data in the database. The system executes a registration request process for the data of the registration request, and records the data in a form that can be displayed on an unprocessed registration request list screen. At this time, the system notifies a registration/management division via e-mail, etc. that the registration request is made. In response to the user registration request, the management division of user registration activates a user registration screen #3 from a menu screen #4 of the system, and learns that the registration has been made because of a transition made to the unprocessed registration request list screen #7. Then, an access right to this system is set for the user who makes the registration request. Its details will be described later. The management division sets the access right in response to the registration request, so that the user can use this system within the scope of the given access right. A user registration information change screen #5 is provided so that the management division changes, deletes, etc. an access right.

The user proceeds from the initial screen #1 to a login screen #3, for example, with the press of a login button, based on the accepted registration request. When the user successfully logs in to the system on the login screen #3, a menu screen #4 appears. From the menu screen #4, a term description screen can be open in order to view a description of a term used for the display.

The user can proceed to each of screens with the click of a button to each of the screens on the menu screen #4.

Search/Inquiry of Agreement Information

An agreement information search/inquiry function is provided to obtain target agreement information based on a predetermined key. Its output is made as an agreement list as described above, or as agreement contents or balance data of an agreement original (for example, a summary of the agreement). As this search/inquiry, screens to which the display can proceed from the menu screen #4 of FIG. 7 are an agreement management number searchscreen#8, a patent and others number search screen #9, a party and others search screen #11, an agreement relevant division search screen #12, a text data traverse search screen #13, and an other search screen #14.

From the patent and others number search screen #9, the display proceeds to a number specification method screen #10, on which the user can view the description of how to input a number of a patent, etc. If the user does not know a particular party (company code) when he or she specifies the party, the user can proceed from the party and others search screen #11 to a code inquiry screen 1, on which he or she can examine the code of the party. If a company code is input as a party from the party and others search screen #11, agreement information in which the party is involved is searched. The user can proceed also from the agreement relevant division search screen #12 to a code inquiry screen #2 in order to examine a code of a relevant division.

On the other search screen #14, the user can open a search method description screen #15, on which he or she can view a description of a search method. Additionally, the user can open a code inquiry screen #16, on which he or she can search for a necessary code. When the user searches for a necessary code, he or she opens from the code inquiry screen #16 a code inquiry screen n of various types used for the search, and searches for the target code. The user who obtains the search method and the code in this way inputs a search conditional expression from the other search screen #14. The input search conditional expression is displayed on a conditional expression display screen #17.

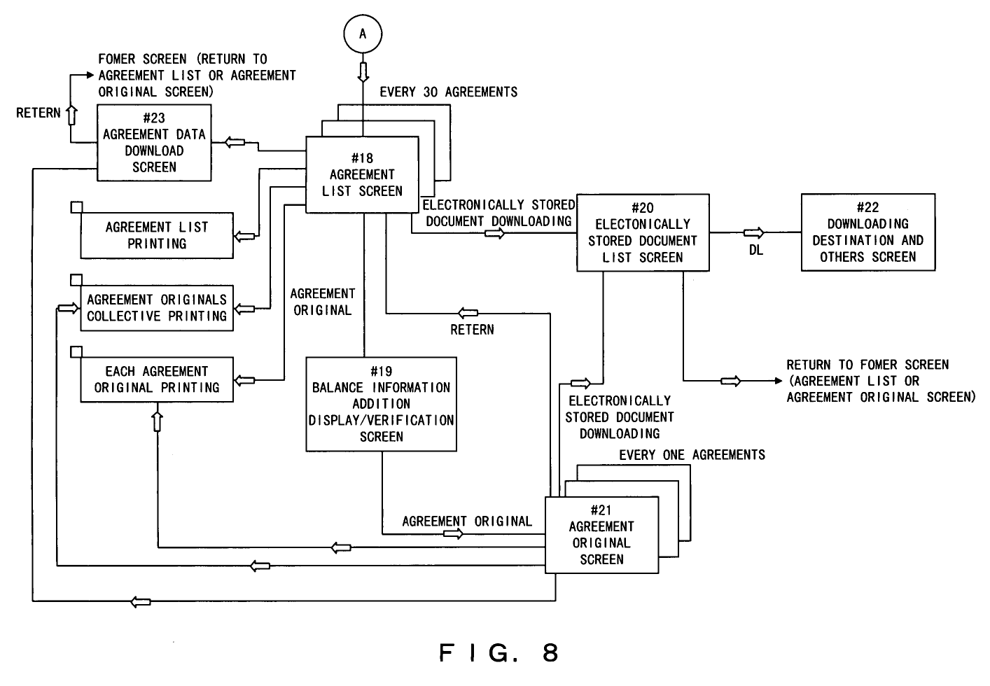

When the search is made from a search screen to which a transition can be made from the menu screen #4, an agreement list screen #18 of FIG. 8 is displayed. On the agreement list screen, for example, every 30 agreements are displayed, and the display can switch to a preceding or succeeding page. However, this screen can be implemented as a scroll screen on which all of agreements are displayed. From the agreement list screen #18, the display can proceed to an agreement data download screen #23, an agreement original screen #21, or an electronically stored document list screen #20. Since some users do not require balance data for the display or the printing of an agreement original. A balance information addition display verification screen #19 is provided as a screen for selecting whether agreement data is output with or without balance data, in this preferred embodiment. If such a selection is not required, there is no need to provide the verification screen #19.

Additionally, on the agreement list screen #18, agreement list printing, agreement originals collective printing, and each agreement original printing can be made. If downloading of an electronically stored document is specified from the agreement list screen #18, an electronically stored document list screen #20 is displayed. Then, if downloading of a particular electronically stored document is specified, a downloading destination and “others” screen #22 is displayed. Upon completion of the downloading, this screen#22 is closed. Additionally, if the electronically stored document list screen #20 is open from the agreement list screen #18, the display can also return to the agreement list screen #18. Or, if the electronically stored document list screen #20 is open from the agreement original screen #21 to be described later, the display can return to the agreement original screen #21. From theagreementoriginalscreen#21, the display can proceed to the electronically stored document list screen #20, the agreement list screen #18, or the download screen #23. Furthermore, from the agreement original screen #21, agreement originals collective printing, or each agreement original printing can be made.

If particular agreement data is specified on the agreement list screen #18, the display proceeds to the agreementdatadownloadscreen#23, on which the agreement data is downloaded. If the agreement data download screen #23 is open from the agreement listscreen#18, the display can return to the agreement list screen #18. Or, if the agreement data download screen #23 is open from the agreement original screen #21, the display can return to the agreement original screen #21.

With the click of an implementation report (such as royalty report) state inquiry button on the menu screen #4 of FIG. 7, the display makes a transition to an implementation report (such as royalty report) state inquiry screen #25. An agreement may sometimes include an obligation article to submit an implementation report (such as royalty report) in advance for a royalty payment or receipt stipulated as a consideration condition. A bill for a money amount to be paid is issued based on the submission/receipt of an implementation report (such as royalty report). Management division information (code), conditions such as a term, submission/receipt, etc. are specified on the implementation report (such as royalty report) state inquiry screen #25, whereby an implementation report (such as royalty report) state list of a target agreement is displayed on the screen. Additionally, with the click of a print button, the implementation report (such as royalty report) state list can be also printed. Examples of the screens will be described later.

Registration/Modification of Agreement Information

Registration/modification and reedition of agreement contents data, registration/modification of balance data, and registration/modification of an electronically stored document are described next as registration/modification of agreement information.

For agreement information, one management number is assigned to one agreement, and agreement contents data, balance data, etc. are registered under the management number. Here, a consideration condition and balance data based on the consideration condition are stipulated by the unidirectional flow of agreement parties, as described earlier with reference to FIGS. 5 and 6. Namely, a consideration condition is set in accordance with a license granted from a company A to a company B, and a consideration payment (balance data) from the company B to the company A is incurred under the consideration condition, so that a running royalty, etc. are paid to the company A (this is assumed to be a case 1). However, depending on an agreement, licenses are mutually granted between companies A and B, consideration conditions are set up mutually, and consideration payments are mutually incurred (this is assumed to be a case 2).

Additionally, there is an agreement among three or more parties such as companies A, B, C, etc., a license is granted from the company A to the companies B and C, consideration conditions are respectively set for the companies B and C, and royalty incomes are earned from the companies B and C (this is assumed to be a case 3).

There is also an agreement among 3 parties or more such as companies A, B, C, etc., such that a license is granted from the companies B and C to the company A, consideration conditions are set by the companies B and C for the company A, and payments of running royalties, etc. from the company A to the companies B and C are respectively incurred (this is assumed to be a case 4). Basically, patterns of agreement having consideration conditions can be classified as the cases 1 to 4. However, how to set a plurality of consideration conditions in one agreement, namely, how to manage an agreement which incurs a plurality of pieces of balance data as in the cases 2 to 4 becomes a problem. Especially, there arises a problem: which of the parties has a right, to whom a right is given, and how these identifications are made, in all of the cases 1 to 4 when viewed from the system side. The present invention can also cope with these cases 2 to 4.

One of solutions to the above described problem is as follows: a subnumber is added to a management number in the case (the cases 2 to 4) where a plurality of consideration conditions occur among parties in one agreement, and the agreement is recognized and managed as a plurality of agreements (these are referred to as virtual agreements) when viewed with the management number plus subnumbers, although the agreement is one agreement when viewed with only the management number.

Another solution is as follows: a subnumber is not added, a plurality of management numbers are assigned in correspondence with parties for which a plurality of consideration conditions occur, and an agreement is managed as one agreement having the plurality of management numbers. In this case, each of the plurality of agreement management numbers is a virtual agreement.

Configuration of the agreement management using a subnumber is first described below.

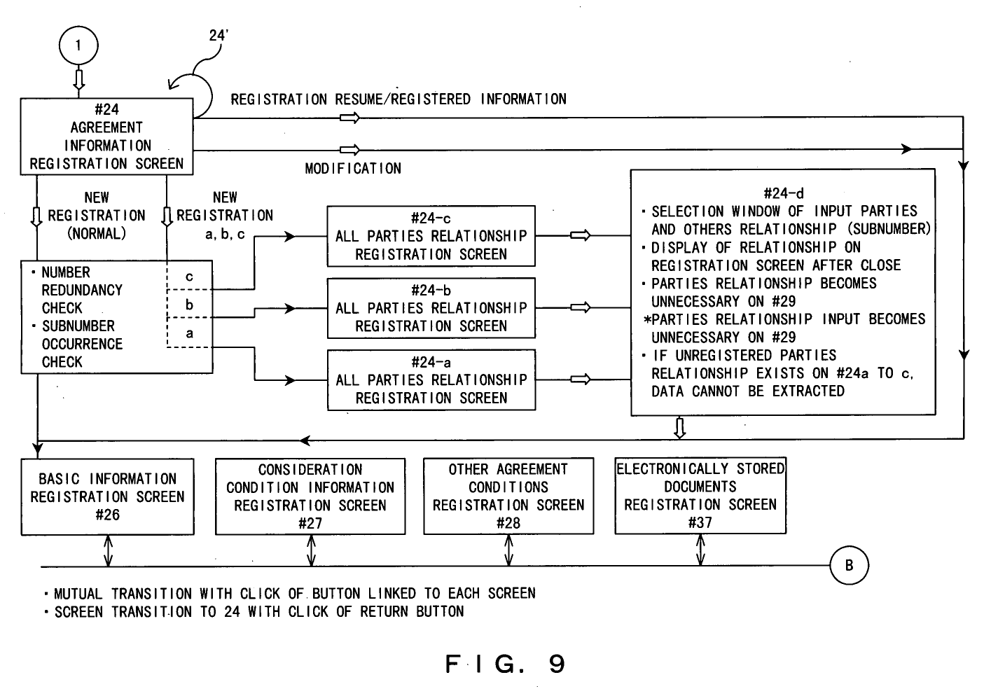

From the menu screen #4 of FIG. 7, the display can proceed to an agreement information registration screen #24 of FIG. 9. On the agreement information registration screen #24, registration resume/registered information modification, reedition, new registration (normal case (corresponding to the case 1)), and special cases (a plurality of registrations a (corresponding to the case 2), b (corresponding to the case 3), and c (corresponding to the case 4) can be made. For the registration resume/registered information modification or the reedition, the display proceeds to a basic information registrationscreen#26. Here, there edition is a reedited agreement to which an addition or a modification is made (an original agreement plus a memorandum of understanding), when part of the agreement is later added or modified with the memorandum of understanding, etc., With the reedition, a plurality of modifications are sometimes made to one agreement. In such a case, reedition is repeatedly made.

For the normal new registration (the case 1), a number redundancy check and a subnumber occurrence check are made, and the display proceeds to a basic information registration screen #26.

For the special new registrations (the cases 2 to 4), after the number redundancy check and the subnumber occurrence check are made, a selection is made from among menu items for making a plurality of registrations a (the case 2), b (the case 3), and c (the case 4). If a is selected, an all parties relationship registration screen #24-a is open. If b is selected, an all parties relationship registration screen #24-b is open. If c is selected, an all parties relationship registration screen #24-c is open. After a parties relationship is registered respectively, the display proceeds to a screen #24-d, on which a selection window for a parties and “others” relationship (subnumber) to be input is displayed. When a subumber is selected, the selection window of a subnumber is closed, the parties relationship is verified on the registration screen, and the display proceeds to the basic information registration screen #26.

On the all parties relationship screen #24-a (the case 2), companies A and B can be respectively stipulated as a licensor and a licensee if the setting direction of a consideration condition is from the company A to the company B, or the relationship between the licensor and the licensee becomes reverse if the setting direction of a consideration condition is from the company B to the company A, and an agreement is recognized to be two virtual agreements. That is, the system can identify which piece of agreement information to be registered, and can also display a licensor according to a management number plus a subnumber (for example, −1, −2 are added).

Additionally, on the all parties relationship screen #24-b (the case 3), two directions where a consideration condition is set “from the company A to the company B” and “from the company A to the company C” occur. In this case, the agreement becomes two virtual agreements in which the company A is a licensor. The system can manage these virtual agreements with a management number plus subnumbers in a similar manner as in the above described case.

Furthermore, on the all parties relationship screen #24-c (the case 4), two directions where a consideration condition is set “from the company B to the company A” and “from the company C to the company A” occur. In this case, the agreement becomes two virtual agreements in which the company A is a licensee. The system can manage these virtual agreements with a management number plus subnumbers in a similar manner as in the above described cases.

The above described cases are the examples of an agreement concluded between two or three parties. The case of an agreement concluded among four parties or more can be coped with by generating subnumbers with a combination of the above described cases 1 to 4.

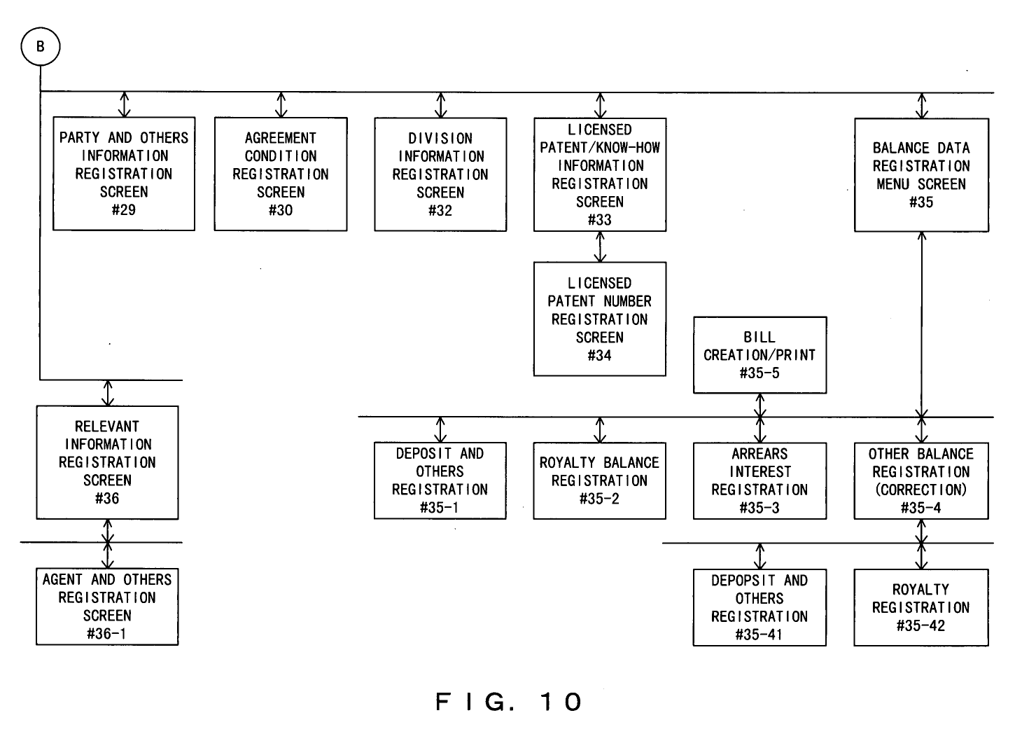

If any of the all parties relationship registration screens 24-a, b, c is selected from the agreement information registration screen #24, the system generates and adds the above described subnumber. Then, a user inputs necessary data on each registration screen as one agreement, whereby the agreement is registered to the system as agreement management data. Screens, which can make a transition from/to the basic information registration screen #26 with the click of a button linked to each screen after agreement bibliographical items, etc. are registered on the basic information registration screen #26, are a party and others information registration screen #29, an agreement condition registration screen #30, a division information registration screen #32, a licensed patent/know-how information registration screen #33, a balance data registration menu screen #35, and a relevant information registration screen #36, which are shown in FIG. 10, in addition to a consideration condition information registration screen #27, an other agreement conditions registration screen #28, and an electronically stored document registration screen #37. If a patent is selected on the licensed patent/know-how information registration screen #33, the display proceeds to a licensed patent number registration screen #34, on which a number of the patent is registered. On the relevant information registration screen #36, information of an agent, etc., and expenses such as a consultation fee, a lawsuit cost, etc. can be registered. From the balance data registration menu screen #35, the display makes a transition to a deposit and others registration screen #35-1, a royalty balance registration screen #35-2, an arrears interest registration screen #35-3, an other balance registration screen #35-4, or a bill creation/print screen #35-5, on which respective registration processes can be executed. From the other balance registration screen #35-4, the display makes a transition to a deposit and others registration screen #35-41, or a royalty registration screen#35-42, on which data as the other balance can be registered.

Up to this point, description is provided from the addition of a subnumber of a virtual agreement to subsequent agreement information registration processes by mainly referring to the screen transitions. The case where a subnumber is not added and one agreement is handled with a plurality of management numbers is described next as a virtual agreement process. In this case, the screens #24-a, b, c, and d on which a subnumber is added become unnecessary as transition screens. In the above described cases 2 to 4, management numbers such as ABC1, ABC2, and ABC3 are grouped and managed as management numbers for one agreement, whereby the numbers can be registered respectively as virtual agreements for the registration of agreement data. Subsequent registration screen transitions are as described above.

How to Decide an Agreement Party

The above described cases 1 to 4 are cases where a consideration condition accompanying right permission as an agreement target, and a consideration payment (deposit, royalty, etc.) of at least one party is incurred, when the parties of the agreement are registered. In the meantime, there is an agreement by which a consideration payment between parties is not incurred even if a license is granted, and an agreement by which a license is not granted (also a consideration is not incurred in this case). Furthermore, for parties stipulated by an agreement, there are cases such as a case where one of the parties becomes a licensor, and the other becomes a licensee, or a case where the parties become neither a licensor nor a licensee (this is referred to as other parties). For example, if attention is focused on a company A, there are three cases: the company A can possibly become a licensor, a licensee, or other party. When a user inputs data of a party involved in an agreement as agreement data, the system side must identify and record to which of a licensor, a licensee, and other party the input party data corresponds.

Here, the above description is provided by assuming agreement parties to be a licensor and a licensee. However, for agreement parties, there are various agreement forms where a right is transferred, a right is not claimed (a right is not exercised), etc. in addition to a form where a right is permitted. Parties in these forms are called in a variety of ways depending on an agreement, such as a licensor, a licensee, a transferor, a transferee, a provider, user, etc. In this preferred embodiment, a relationship of these rights is generically called or unified as a licensor and a licensee. However, the present invention is not limited to the licensor and the licensee, and processes of registration, etc. may be executed with different names depending on each agreement form.

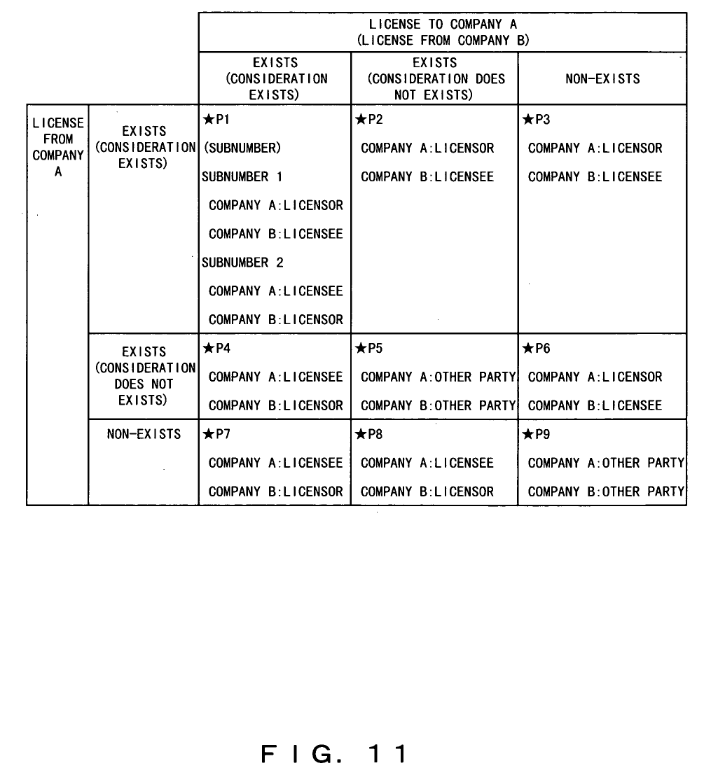

FIG. 11 shows the classification of agreement party relationships for enabling an agreement party relationship to be determined in the system.

With the system according to the preferred embodiment of the present invention, decision of a licensor and a licensee, and decision of others (parties are completely equal in positions, such as a cross license, etc.) are made with an agreement party relationship.

In normal cases, an agreement is concluded between two companies, and a license is granted from one to the other. An agreement among many companies is separated into agreements between two parties, and managed by registering a plurality of contents of permitted rights in the above described data structure managed with one basic information.

Agreement forms can be categorized into 9 types such as patterns P1 to P9 of FIG. 11. Assume that parties are companies A and B. In this case, their agreement form is categorized as any of a form where a right is permitted and there is a consideration condition from the company A, a form where a right is permitted and there is no consideration condition from the company A, a form where a right is not permitted from the company A, a form where a right is permitted to the company A and there are consideration conditions to the company A (namely, from the company B), a form where a right is permitted and there is no consideration condition to the company A, and a form where a right is not permitted to the company A. In the matrix shown in FIG. 11, for the patterns P2 to P9, the flow of a consideration is a unidirectional flow from one company to the other. Therefore, these patterns can be managed with one piece of agreement data. In the meantime, the pattern P1 occurs in the cases 2 to 4 as described above. For example, the flow of a consideration from the company A to the company B, and the flow of a consideration from the company B to the company A exist as the case 2. Adopted in this case is a method for generating data which describes the flow of the consideration from the company A to the company B, and data which describes the flow of the consideration from the company B to the company A as agreement data even when the agreement contents of the P1 are arranged with one agreement, for making the association between these pieces of data, and for managing the data. To make this association, there is a method for uniquely obtaining two management numbers as management numbers assigned to the agreement data, and for recording the association between both of the management numbers, for example, by recording the management numbers to a table in correspondence, and a method for adding subnumbers to one management number, and for registering and managing agreement information in correspondence with the subnumbers. For example, if the management number is “01111”, data which describes the flow of a consideration from the company A to the company B is managed with a number “01111-1”, and data which describes the flow of a consideration from the company B to the company A is managed with a number “01111-2”. In this case, the number “01111”, which is not the subnumbers, of the respective pieces of data is viewed, so that both of the data are proved to indicate the flows of considerations accompanying the license granted by the single agreement. Besides, there is an advantage that the agreement can be managed with the data structure which describes a unidirectional flow of a consideration without newly providing a data structure for the case where bidirectional flows of considerations exist.

It can be said that the above described management method is a virtual agreement method as described above, because a plurality of agreements are recognized to virtually exist for one agreement. Also the cases 3 and 4 for the pattern P1 are similar.

In the cases of the patterns P5 and P9, there are no flows of considerations between the companies A and B. Therefore, the companies A and B are recognized to be equal in positions, and determined to be other parties.

FIG. 11 shows the patterns where the parties are assumed to be the companies A and B. However, even if three parties or more exist, the pattern P1 can be processed as virtual agreements as in any of the cases 2 to 4. Or, the patterns P2 to P9 can be processed by paying attention to the company A, and by making a determination.

A registration/modification system and a search system of agreement information are described below based on configuration examples of screens.

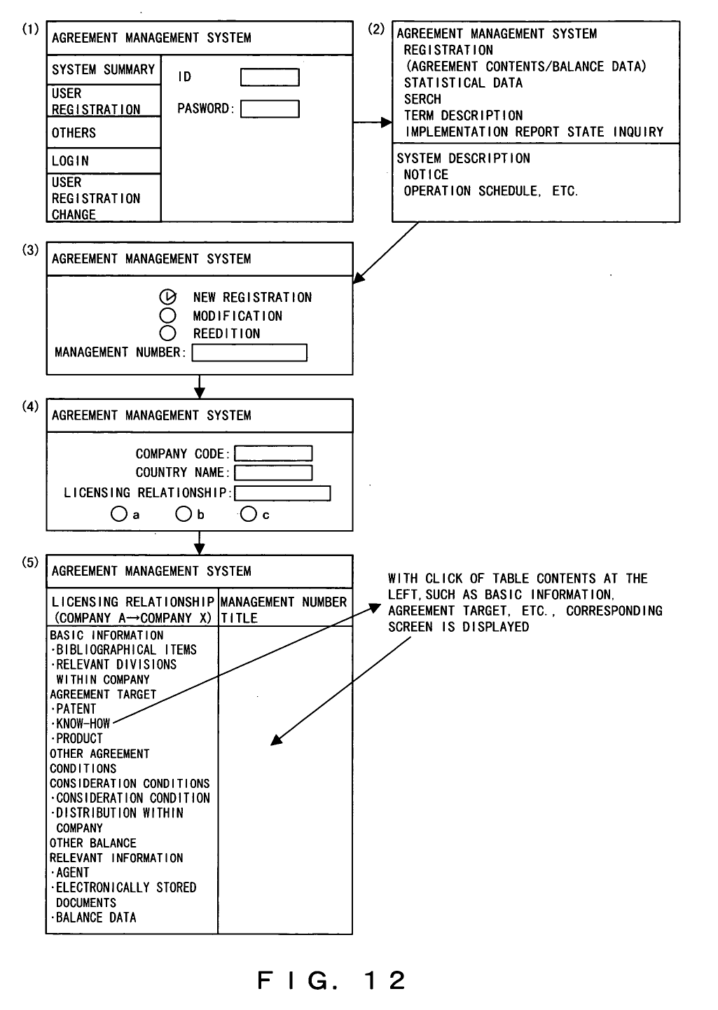

FIG. 12 exemplifies the configuration of a registration/modification screen.

Main screens, via which a transition is made from a login screen to an agreement database registration screen, are exemplified.

(1) of FIG. 12 shows a login screen (#3 of FIG. 7). This screen prompts a user to input his or her ID and password. On the login screen, buttons such as a system summary button describing the system, a user registration button for registering a user, a login button, and a user registration change button are provided as the left fields. When a user logs in to the system, a transition is made to a menu screen of (2) of FIG. 12 (#4 of FIG. 7). On the screen of (2), a system notice is displayed, and buttons such as agreement contents/balance data registration, statistical data, search, term description, implementation report (such as royalty report) state inquiry, and logout are provided. Also on this screen, the description of the system can be viewed. (3) of FIG. 12 shows a screen (#24 of FIG. 9), which is displayed after a registration button is selected. On the screen of (3), buttons such as new registration, modification (registration resume/registered information modification), and reedition are provided. A management number field is intended to input the management number of agreement data to be modified or reedited when modification or reedition is made. If a new registration is selected on the screen of (3), a transition is made to a screen of (4) next. On the screen of (4) (#24′ of FIG. 9), a company code of a counterpart company that makes an agreement as a party (one company, which is a representative of a plurality of companies if they exist, can be input, or the plurality of companies can be input at one time), a country name, a right permission relationship are input. The right permission relationship (including the presence/absence of a consideration) is input, so that the system determines any of the above described patterns P1 to P9, and stipulates a licensor and a licensee. Here, in the cases 2 to 4 for the pattern P1, with the click of any of buttons a, b, and c, a transition is made to the above described #24-a , b, or c of FIG. 9. This example shows a bidirectional license from the company A (company on this side) to a company X (counterpart).

When these inputs are made, a transition is made to a screen of (5) (#26 of FIG. 9), on which a plurality of windows are open. In a field of an agreement management system name in the top stage, the menu in the top stage of the above described screen of (2) is displayed, and a permission relationship is displayed in a left field in the second stage. For example, the relationship input on the screen (4) is displayed. On the screen of (5), the permission relationship from the company A to the company X is displayed. Here, the company A is normally a company on this side. If agreement parties are equal in positions, an arrow becomes a hyphen “-”.

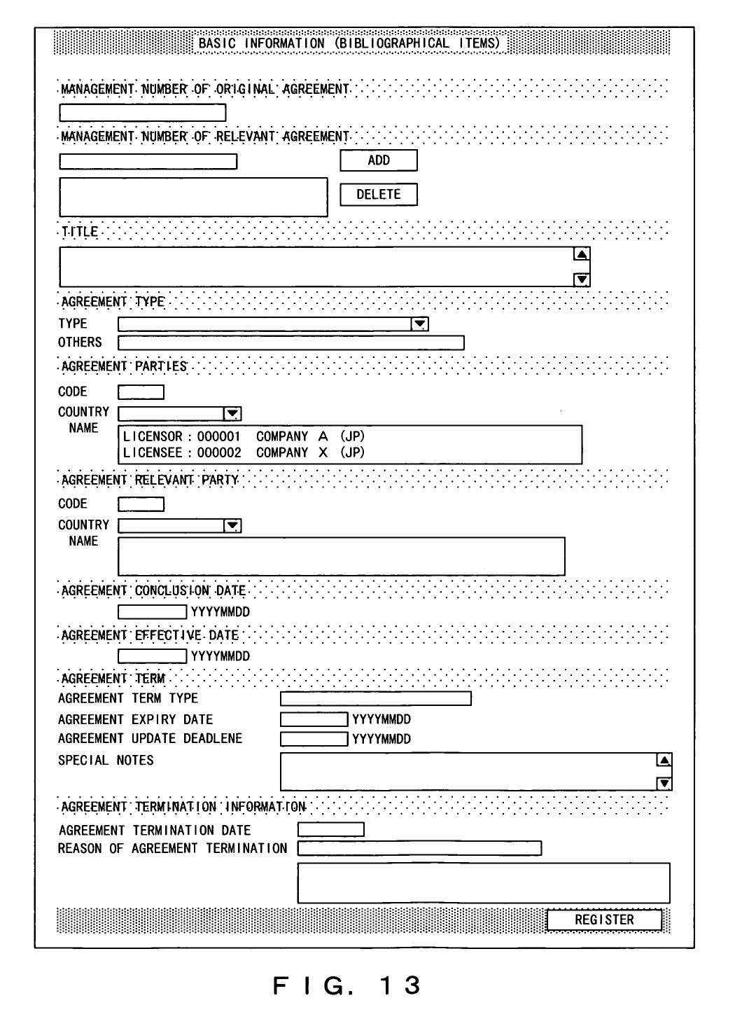

This permission relationship display field allows a user to learn about from whom to whom the contents of a right is permitted in the registration operation of agreement data, etc., which is executed by the user thereafter. In a right field, a management number, and a title indicating the type of an agreement are displayed (this display is made as a result of a user registration operation. By default, nothing is displayed). A lower left field indicates representatives of agreement data items. Namely, basic information, an agreement target, other agreement conditions, consideration conditions, other balance, relevant information, an electronically stored document, balance data, and the like are displayed. These information items correspond to the table of contents. A blank in the right field becomes a basic information registration screen (#26 of FIG. 9) when a transition is made first (this portion is exemplified in FIG. 13). Although contents of the agreement management system field in the top stage on the screens of (3), (4), and (5) of FIG. 12 are not shown, the buttons such as registration, search, etc. in the top stage of (2) are arranged, and the same contents are fundamentally displayed in all cases. Accordingly, even if the screen makes a transition, a user can arbitrarily make a transition to another process. Additionally, a user can reference a term description whenever he or she requires the description.

FIG. 13 exemplifies the agreement basic information (bibliographical items) registration screen.

On the registration screen of bibliographical items of basic information, an original agreement management number, a relevant agreement management number, a title, an agreement type, agreement parties, parties involved in an agreement, an agreement conclusion date, an agreement effective date, an agreement term, and agreement termination information can be registered in detail. If this screen is too large to fit into the display unit, it is scrolled.

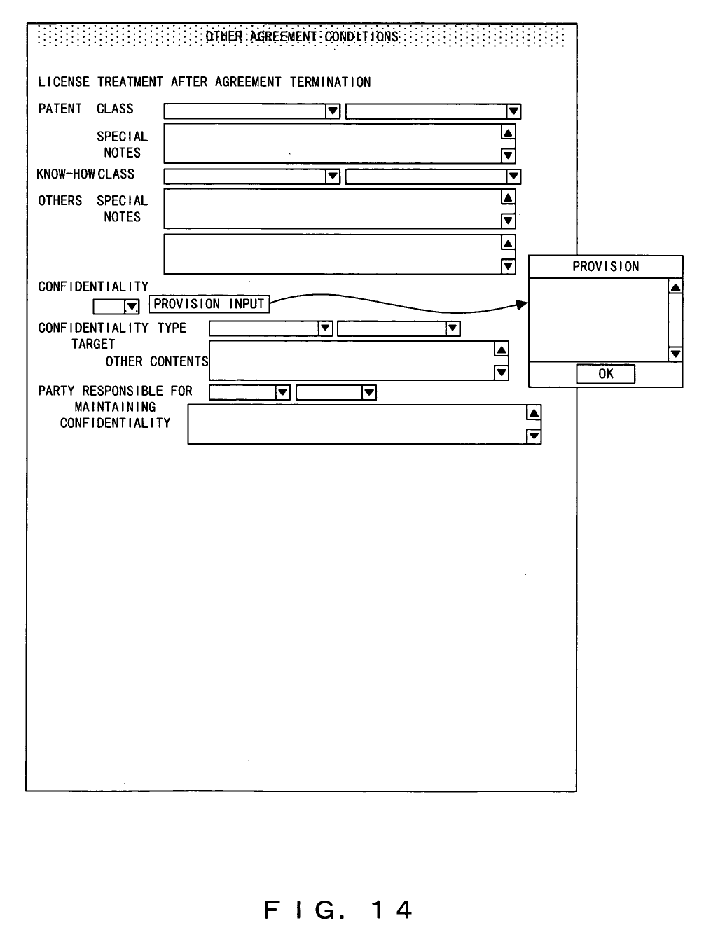

FIG. 14 exemplifies the other agreement condition input screen.

On the other agreement condition input screen, main provisions among agreement provisions can be registered in addition to a stipulation of treating a permitted right after the agreement is terminated, and the like. For example, if a written agreement includes a confidentiality provision, another window is open with the click of a “provision input” button of a data input part of confidentiality, and the above provision can be registered. In this window, main provisions such as a licensing provision, etc. can be registered. This provision registration is intended to allow a user to easily verify how a particular provision is stipulated when the agreement original is displayed with a pop-up window as a result of a search to be described below. For all of provisions of the written agreement, the following registration and search/inquiry of an electronically stored document is made.

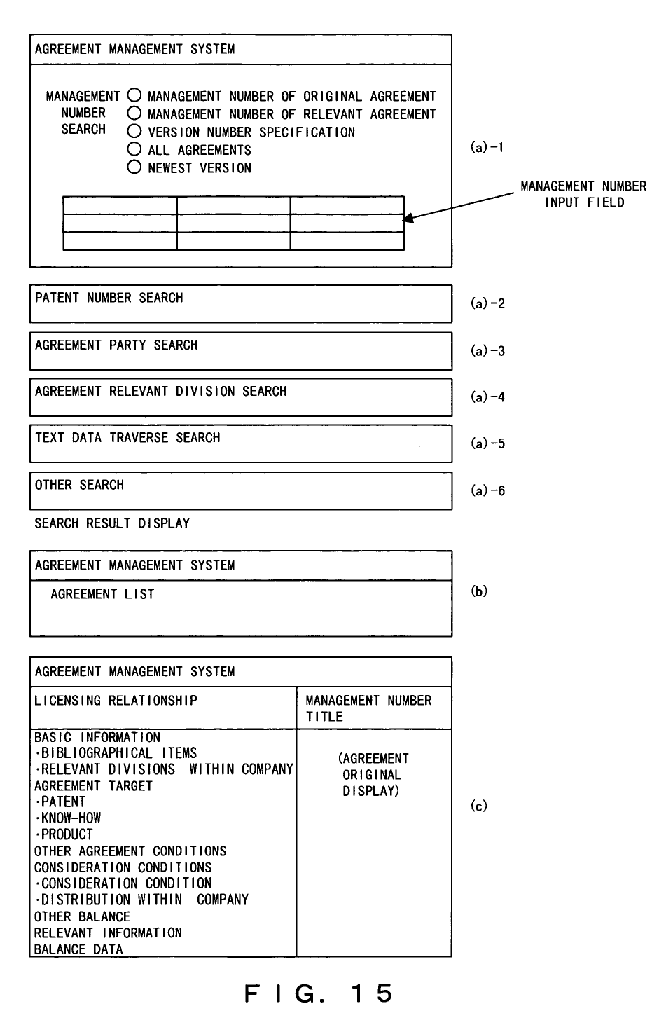

Search screens are exemplified next. FIGS. 15 to 20 show configuration examples (for search) of the respective screens.

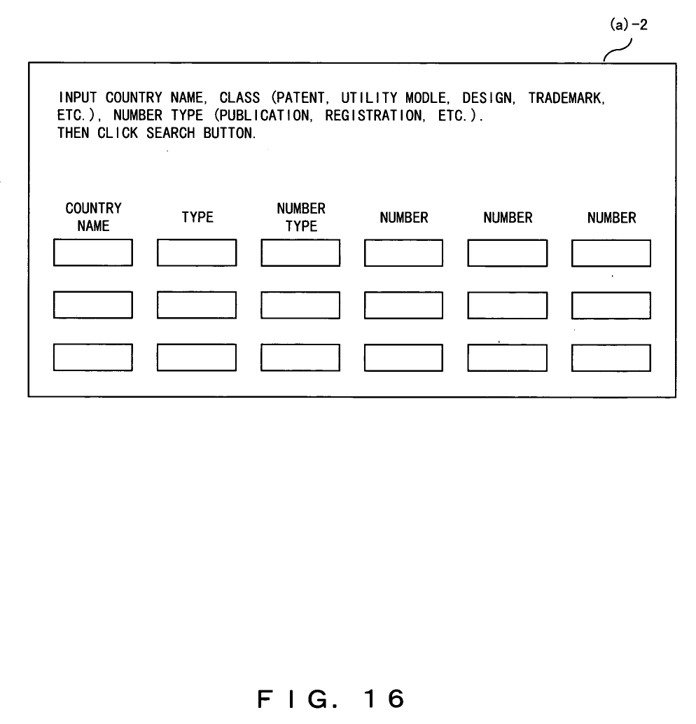

FIGS. 15(a)-1, 15(a)-2, 15(a)-3, 15(a)-4, 15(a)-5, and 15(a)-6 respectively exemplify screens of a management number search, a patent number search, an agreement party search, an agreement relevant division search, a text data traverse search, and other search. FIGS. 15(a)-2 to 15(a)-6 will be described with reference to other figures (FIGS. 16, 17, 18, 19 and 20). The screens 15(a)-1 to 15(a)-6 respectively correspond to #8, #9, #11, #12, #13, and #14 of FIG. 7.

On the management number search screen of FIG. 15(a), a search method is specified from among an original agreement management number and a relevant agreement management number, a management number is input to a management number input field after a version number of agreement data is specified, and the search is started, so that an agreement list of FIG. 15(b) is displayed (#18 of FIG. 8). Then, if one agreement is selected from the list, an agreement original indicating the contents of the registered agreement is displayed along with the management number and the title of FIG. 15(c) (#21 of FIG. 8).

FIG. 16 exemplifies the patent number search screen. With the click of a search button after inputting a country name, a class (patent, utility model, design, trademark, etc.), a number type (publication, registration, etc.), and a patent number, etc., a search is executed, and an agreement list like that of FIG. 15(c) is displayed. Subsequent operations are the same.

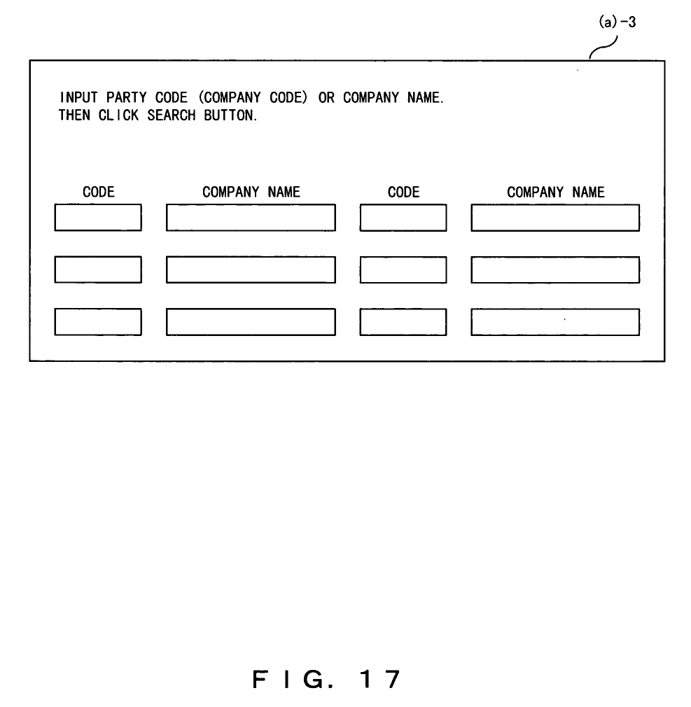

FIG. 17 exemplifies the agreement party search screen.

With the click of a search button after inputting a party code (company code) or a company name, an agreement list is displayed.

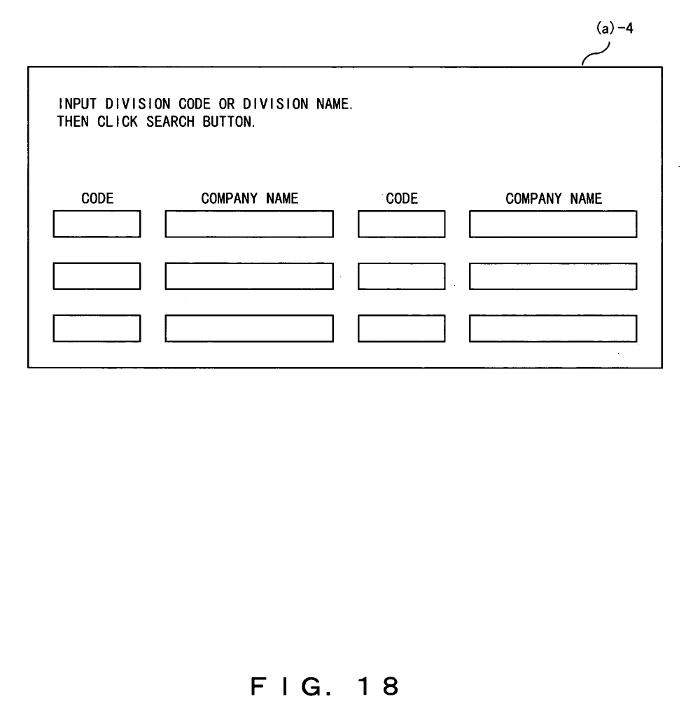

FIG. 18 exemplifies the relevant division search screen.

With the click of a search button after inputting a division code or name, an agreement list is output.

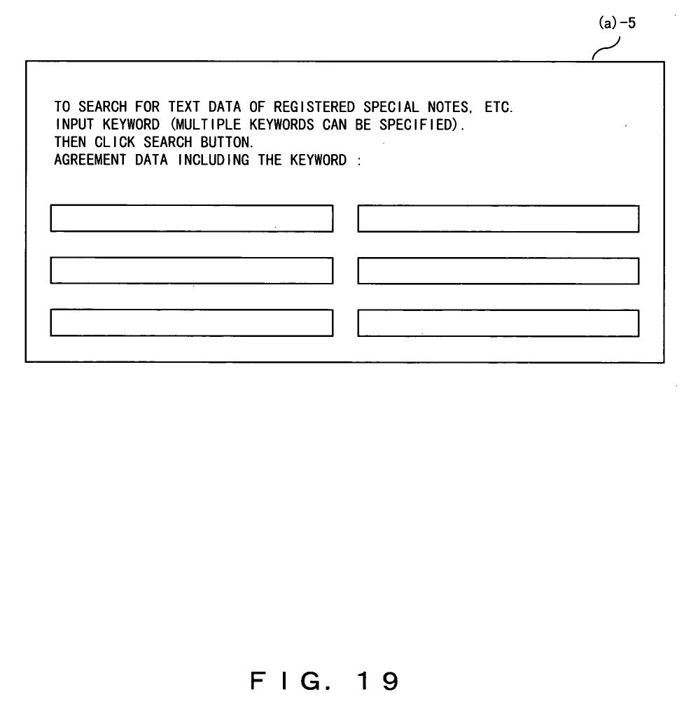

FIG. 19 exemplifies the text data traverse search screen.

This is a screen for searching for text data such as a registered special note, etc. in a traverse manner. With the click of a search button after inputting a keyword, a list of agreement data including the keyword is displayed. A plurality of keywords can be specified.

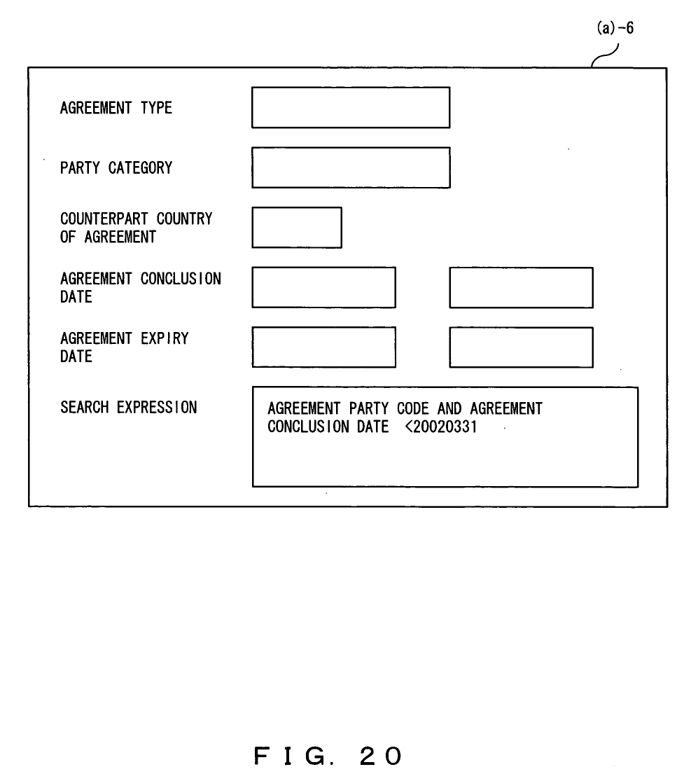

FIG. 20 exemplifies the other search screen.

On the other search screen, a search can be made with an agreement type, a party classification, an agreement counterpart country, an agreement conclusion date, an agreement expiry date, a search expression, etc. A search expression of FIG. 20 shows one input example of a search expression.

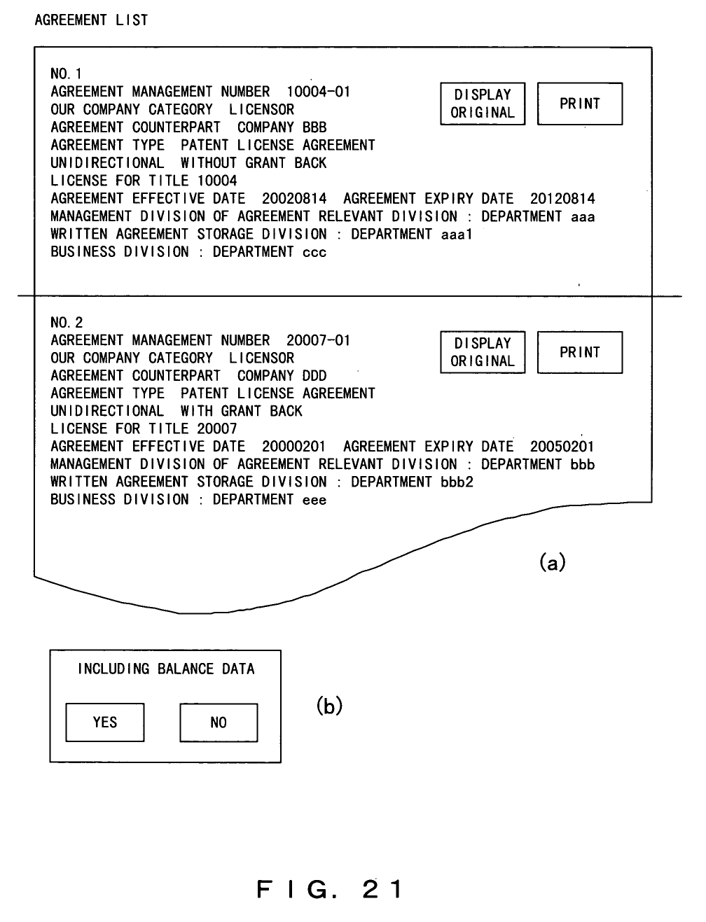

FIG. 21 exemplifies the display of an agreement list resultant from a search.

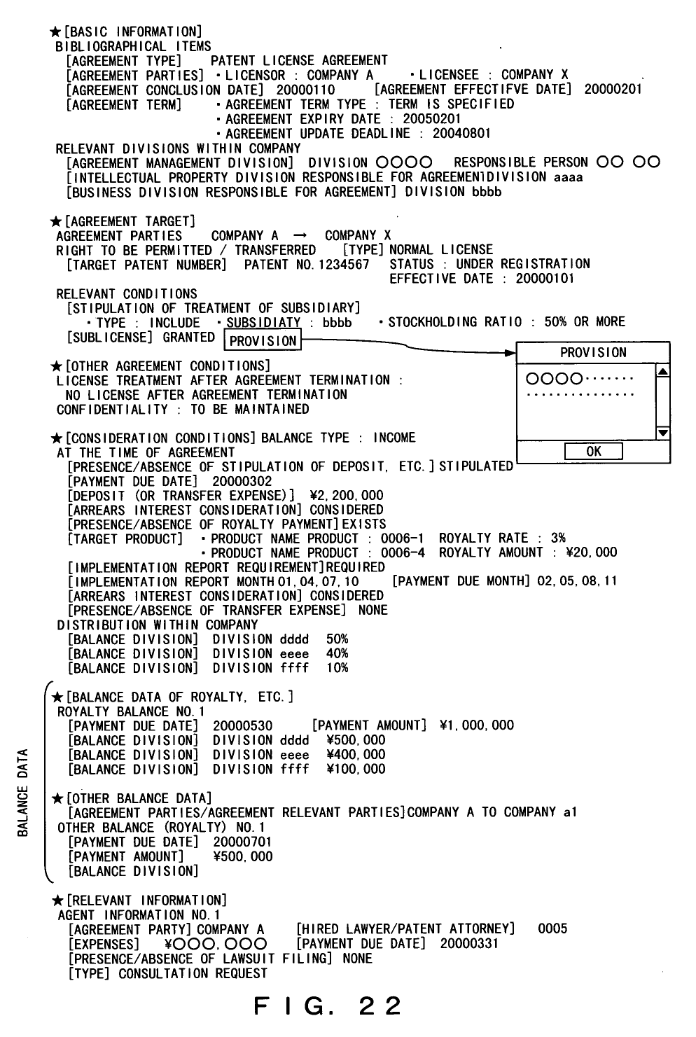

In the agreement list, an agreement management number, and bibliographical items, etc., such as classification of a company on this side indicating whether the company on this side is a licensor, a licensee, or others (equal in positions in an agreement), an agreement counterpart, an agreement type, a title, an agreement effective date, an agreement relevant division, a relevant division, an agreement storage division, a business division, etc. are displayed. Additionally, at the side of the bibliographical items of each agreement, a button instructing the display of an original, and a button instructing the printing are provided. With the click of the button instructing the display of an original, a screen of FIG. 21(b) appears, which allows a user to select whether or not to include balance data in output data. When the user selects “YES” or “NO” in this display selection window of balance data, a transition is made to the former display screen (#19 of FIG. 8). Also with the press of the button instructing the printing, a print selection window of balance data appears. Then, a user selects “YES” or “NO”, so that an original which includes/does not include balance data is printed. Even if a user selects an original which includes balance data, the system side prohibits the display or the printing of balance data depending on the access right of the user. FIG. 22 exemplifies the agreement original display.

On the agreement original display screen, the above described contents of agreement data are displayed. Display/non-display of balance data is controlled according to an access right, and only a person who has an access right is allowed to view the balance data.

CSV Downloading of Agreement Data

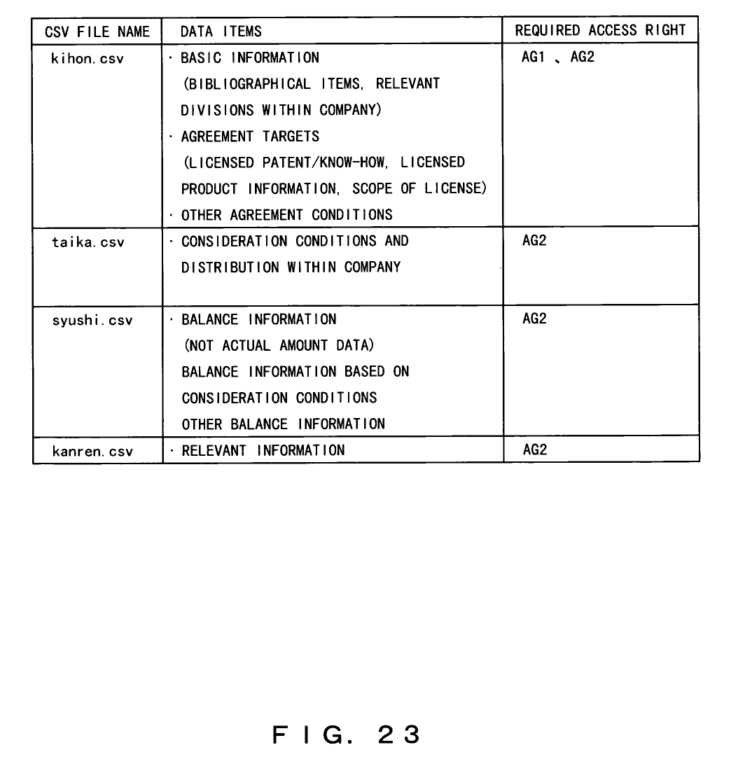

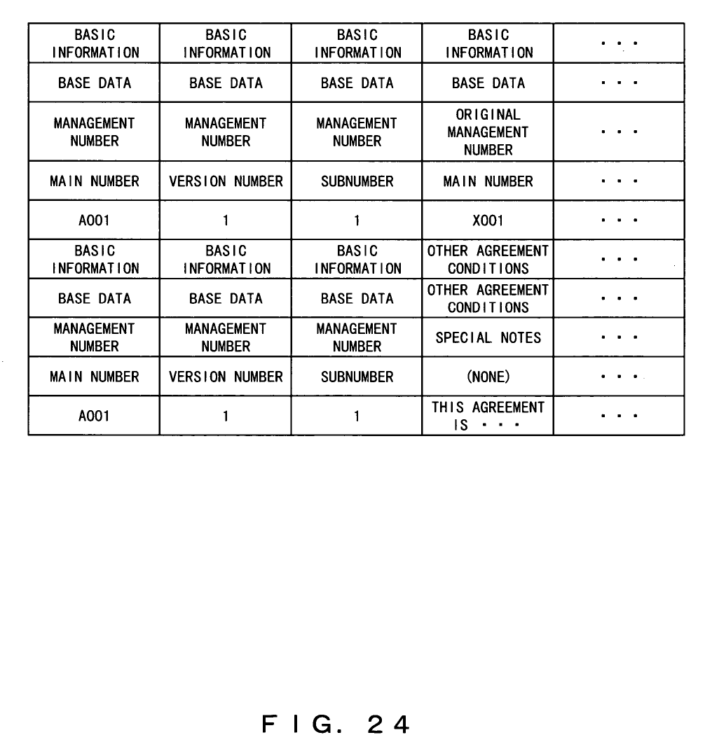

FIGS. 23 and 24 explain the downloading of agreement data in a CSV format and its display.

FIG. 23 shows the downloading type and the format of agreement data. Such a type of selection screen is displayed as #20 of FIG. 8. Actually, only a CSV file name and data items are displayed. An access right required is internal data for checking an access right within the system. For each user, depending on his or her access right, a limitation is imposed on agreement data that he or she can download. In the case of FIG. 23, access rights such as AG1 and AG2 are provided. A user having the access right AG1 can download only basic information, an agreement target, and other agreement conditions when downloading agreement data. A user having the access right AG2 can download all of agreement data items. Agreement data is enabled to be downloaded in a CSV (Comma Separated Value) format. However, if one piece of agreement data has a large amount of information, it is enabled to be downloaded by being separated into 4 types of CSV files. A user downloads target data by specifying any of the 4 types, and a downloading by specifying destination (#22 of FIG. 8). For the downloading, a limitation is imposed on a file that can be referenced depending on an access right.

FIG. 24 exemplifies the configuration of a CSV format.

As shown in FIG. 24, data in a CSV format configures one item of data with a total of 5 rows such as 4 rows as title rows of an item, and one row of data contents. Each item is delimited with a comma in a CSV file. Considering the display of a CSV file with Microsoft Excel (trademark), up to 256 columns are made displayable in the horizontal (column) direction, and up to 65536 rows are made displayable in the vertical (row) direction. An agreement management number (main number, version number, subnumber: blank if there is no version number or subnumber) is always assigned to four items at the beginning of each row in order to identify the contents of data. A data item having a character attribute is enclosed by double quotation marks. Such a data structure is used, so that the type of contents indicated by a data value can be discerned at a glance, even when the data is displayed with Excel. Additionally, a data item having a character attribute and data are processed as a pair. This can avoid a phenomenon that data is made unidentifiable by being merely wrapped around if the data is attempted to be displayed exceeding the number of columns, which is restricted depending on display software (application) such as Excel, etc.

Registration/Modification of Balance Data

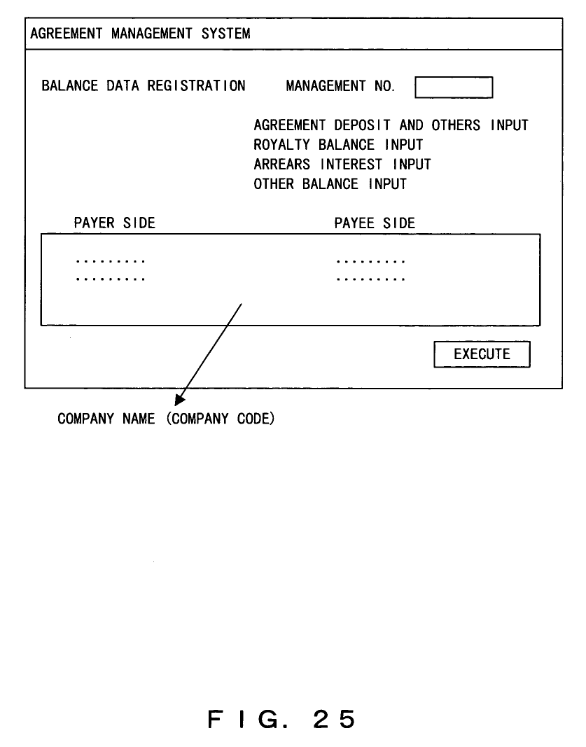

FIG. 25 exemplifies the (registration/modification) configuration of a balance data screen.

In this figure, balance data can be registered. For an agreement indicated by a management number, an input of an agreement deposit, etc., a royalty balance input, an arrears interest input, and other balance input can be made. In a window under the menu items, company names and codes of a payer side and a payee side are displayed. In this window, one relationship between a payer and a payee is selected, a process desired to be executed is selected from among the menu items, and an execution button is clicked, so that a screen for registering balance data is open. The reason why company names, etc. are displayed and made selectable in the window under the menu items is to cope with a virtual agreement. If there are no virtual agreements, a process may be selected by specifying only a management number, and a transition may be made to the next screen with the click of an execution button.

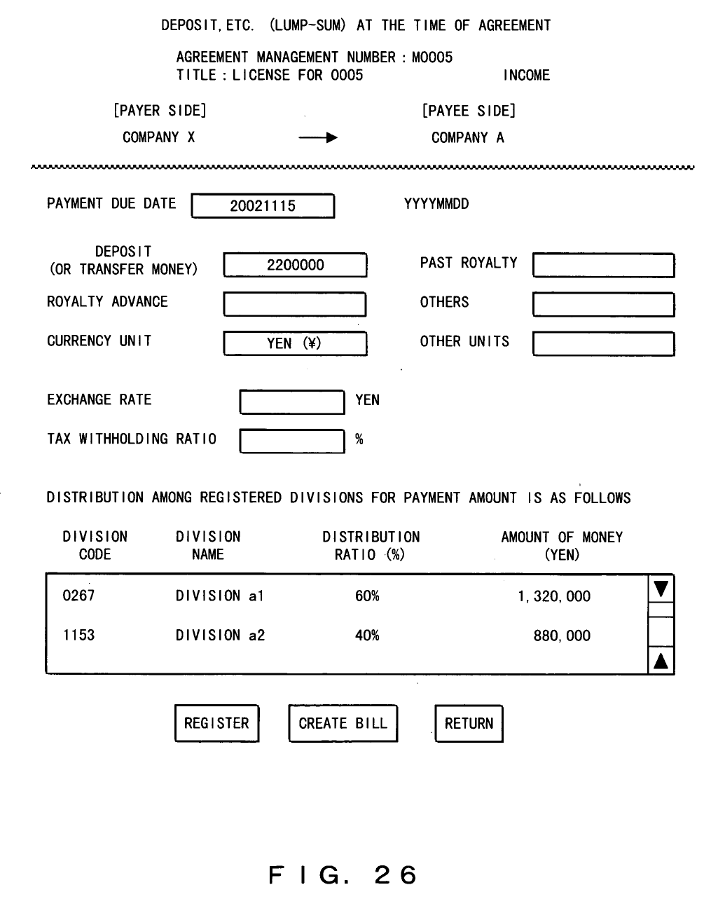

FIG. 26 exemplifies a deposit input screen.

This figure shows contents of a payment such as a deposit, etc. at the time of an agreement by which a payment is made in one lump. This is the case where a deposit of an agreement is paid to a company on this side based on the assumption that a payee side is a company A, which is the company on this side, and a payer side is a company X, which is an agreement counterpart. Besides, a payment due date, a money amount of a deposit or a transfer expense, a past royalty, a royalty advance, a currency unit, an exchange rate, a tax withholding ratio, a distribution ratio among divisions that conclude an agreement, and the like are recorded. A button to record these data items, a button to create a bill, and a button to return to a former screen are provided at the bottom of the screen.

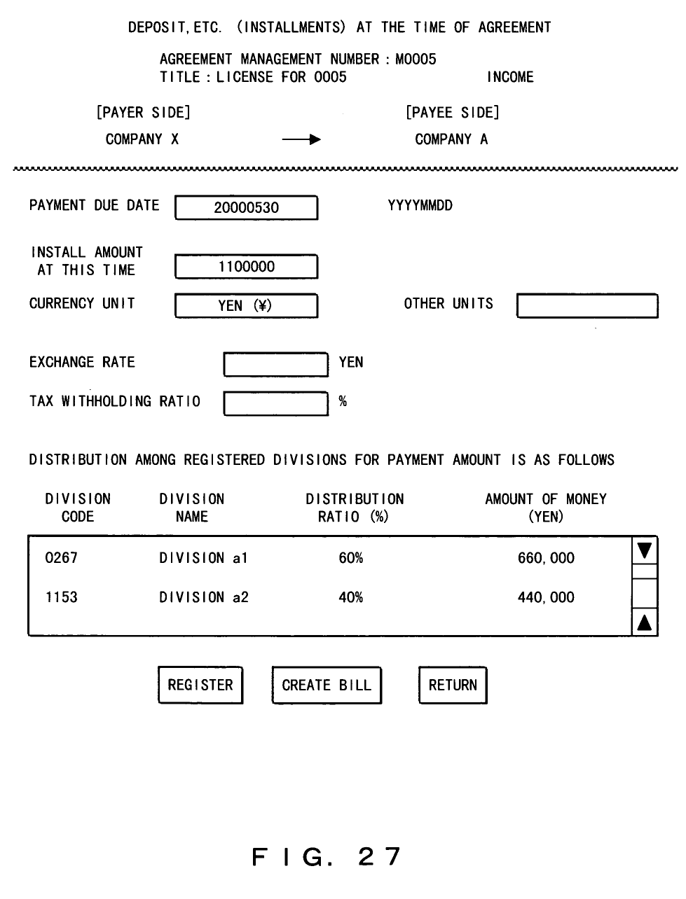

FIG. 27 exemplifies an input screen of installments of a deposit, etc.

In this figure, a money amount of an installment at the current time is indicated in addition to the items shown in FIG. 26.

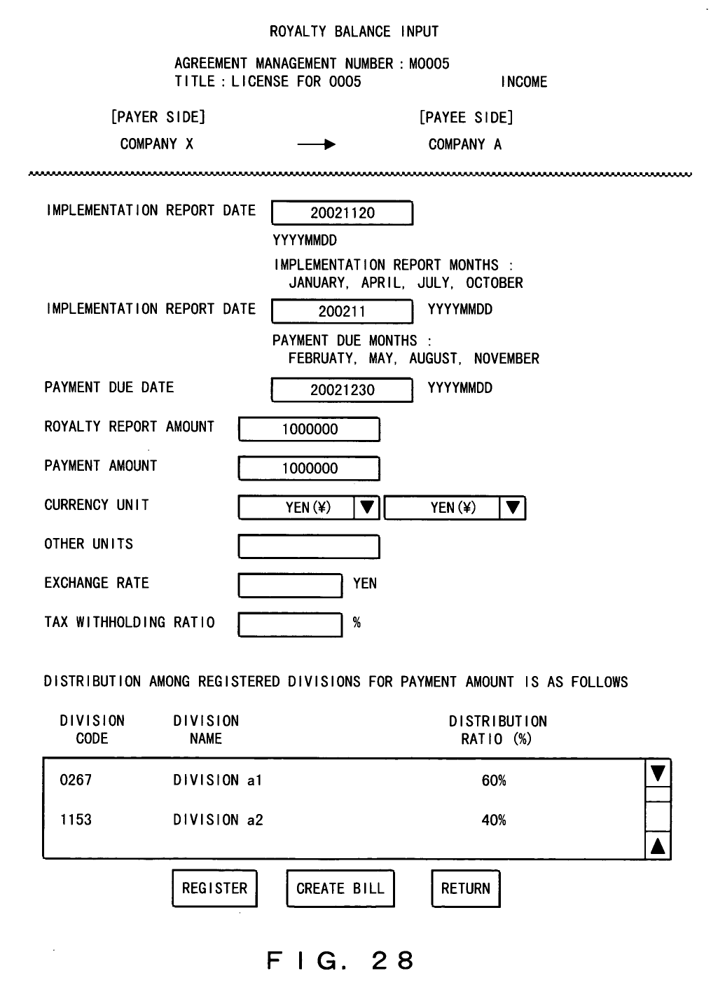

FIG. 28 exemplifies a royalty balance input screen.

Also here, an agreement whose royalty balance is to be input is identified with an agreement management number and a title. A payer side and a payee side are displayed in a similar manner as in the case of a deposit. Besides, an implementation report (such as royalty report) date, a report schedule, a payment due date, a royalty report amount, a payment amount, a currency unit, an exchange rate, a tax withholding ratio, a distribution among divisions, etc. are recorded.

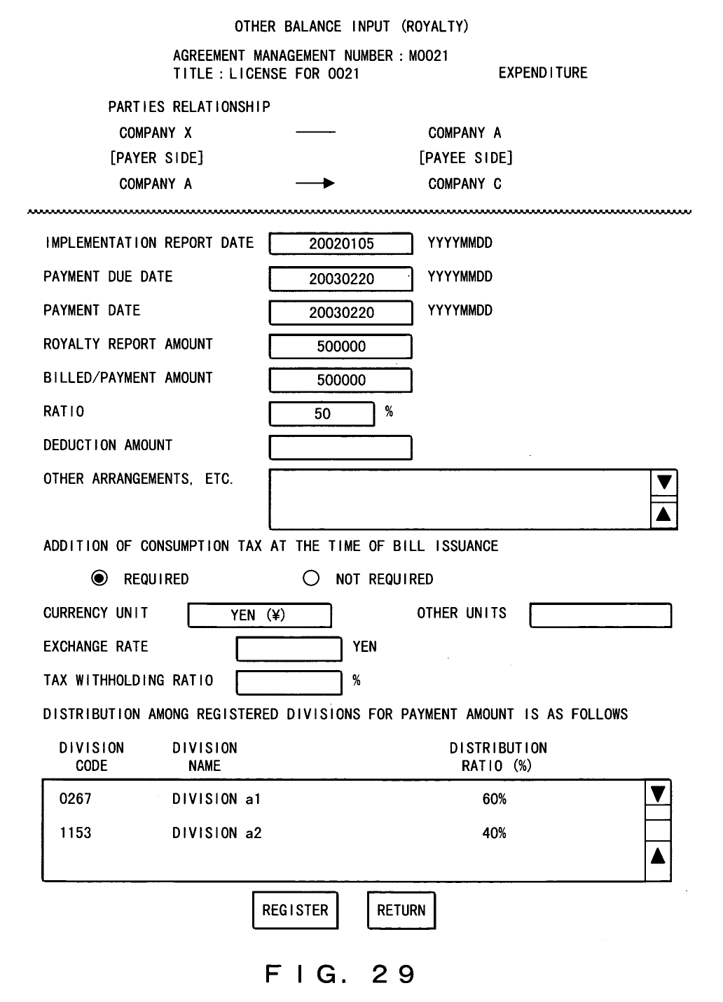

FIG. 29 exemplifies the other balance input screen.

An agreement to be input is specified with an agreement management number and a title. Furthermore, a party relationship, a payer side, and a payee side are displayed. Since this figure is the other balance input screen of a running royalty, items such as an implementation report (such as royalty report) date, a royalty report amount are provided. However, for the other balance input screen of a deposit, etc., these items are not provided. The other items include a payment due date, a payment date, a billed/payment amount, a ratio, a deduction amount, other arrangements, an addition of a consumption tax at the time of bill issuance, a currency unit, an exchange rate, a tax withholding ratio, sharing among divisions, etc. are displayed.

The balance data input screens of FIGS. 26 to 29 are merely examples, and their input item names, the numbers of items, etc. are not intended to limit the present invention.

Implementation Report (Such as Royalty Report) State Inquiry

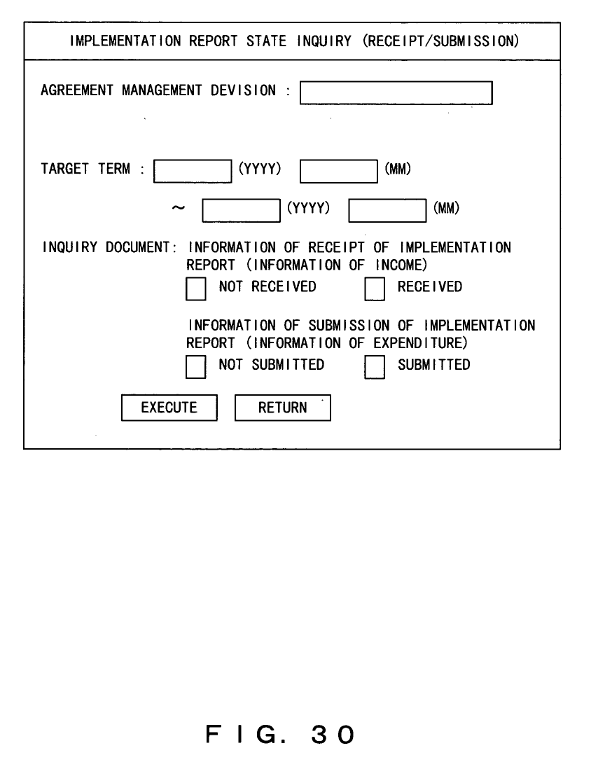

FIG. 30 exemplifies an implementation report (such as royalty report) state inquiry screen (#25 of FIG. 7).

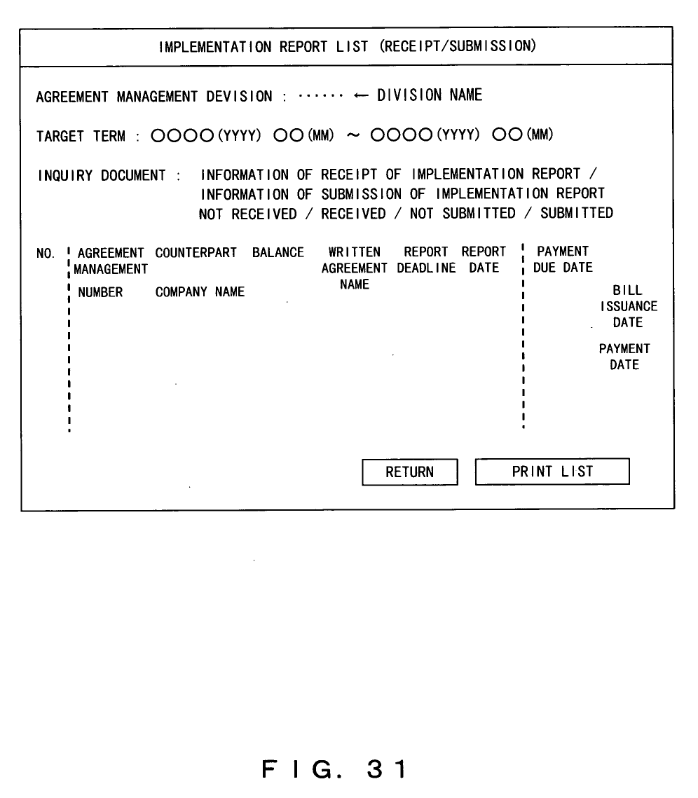

This inquiry screen is intended to manage whether a user in a division which manages an agreement either receives or submits an implementation report (such as royalty report) based on the agreement. In this figure, a code or a name of an agreement management division as a division which manages an implementation report (such as royalty report) accompanying a consideration payment is specified, and a report target term (from month-year to month-year), and a selection of an inquiry document (received/submitted or not received/not submitted for a report, etc.) are specified, so that data of an implementation report (such as royalty report) state in accordance with the agreement managed by the management division can be obtained. Any one or a plurality of selections such as “received”, “submitted”, “not received”, and “not submitted” may be specified. The implementation report (such as royalty report) state can be output as a screen display or print. This screen display is exemplified in FIG. 31.

FIG. 31 exemplifies an implementation report (such as royalty report) state search result screen (#25-1 of FIG. 7).

This figure shows an implementation report (such as royalty report) state list. A division name as an agreement management division, a target term, information of receipt and submission sides of an inquiry document are displayed. Additionally, in the list, a reference number, an agreement management number, a company name of an agreement counterpart, balance, a written agreement name, a report deadline, a report date, a payment due date, a bill issuance date/payment date, etc. are enumerated. An arrangement of the list can be determined arbitrarily. For example, data items are arranged in order of income and expenditure in units of agreement management numbers, and data items indicating that incomes are earned with the same agreement management number from a plurality of companies are listed prior to a payment. Also the payment is similar.

Access Right

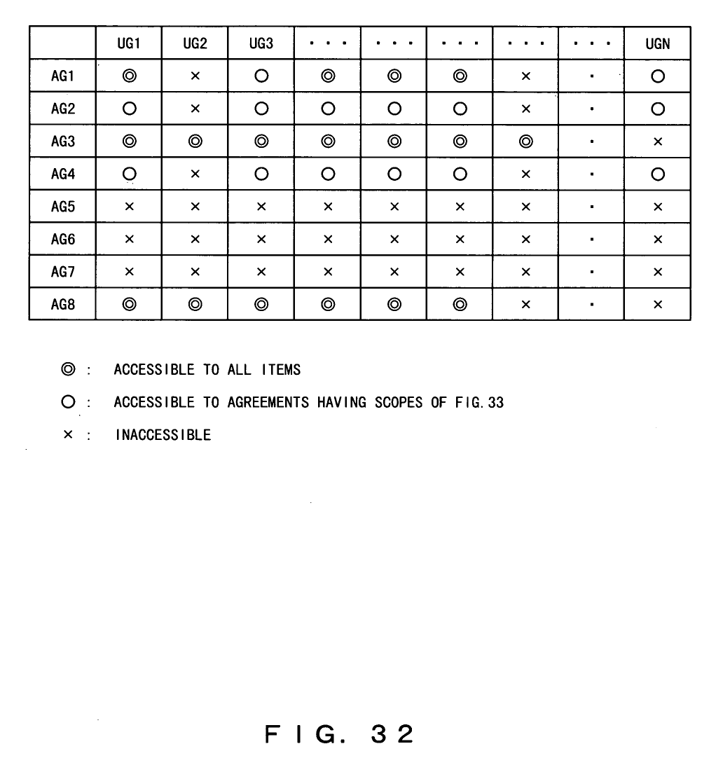

In the agreement management system, how to maintain security is an important issue. Confidentiality must be maintained depending on an agreement in many cases, and a restriction must be imposed even on a person within a company, such as a person in an agreement management division, a division responsible for an agreement, etc., to conceal the information from a person outside a company. Additionally, some agreements must not be made public outside a division. Accordingly, an access right (including reference/registration) to the system must be given to each user, and an access right must be set for each data item/document of registered agreement information (agreement contents data, balance data, electronically stored documents, etc.). The present invention overcomes this issue with the following configuration. FIGS. 32 to 37 explain access rights.

According to the present invention, information to be managed, and divisions that reference the information are classified into groups as follows.

(a) Data to be Registered/Referenced

(1) Data of basic information of an agreement, and data of other agreement conditions are classified as AG1.

(2) Data of a balance amount, such as a consideration condition, etc. of an agreement is classified as AG2.

(3) Data to be displayed as an agreement list is classified as AG3.

(b) Electronically Stored Files

(4) Documents relevant to an agreement (written agreement, etc.) are classified as AG4.

(5) Agreement negotiation documents/materials (minutes, letters to/from a counterpart, etc.) are classified as AG5.

(6) Documents within a company, which accompany agreement negotiation, are classified as AG6.

(7) Balance information (bill, implementation report (such as royalty report), etc.) based on an agreement is classified as AG7.

(8) Others (statistical data, etc.) are classified as AG8.

(b) Divisions to which Users Belong are Classified Into Groups.

(1) AA division is classified as UG1.

(2) AB division is classified as UG2.

(3) AC division is classified as UG3.

(4) . . . (ditto hereinafter) . . .

Then, access rights to various types of information are respectively defined for the user groups as indicated by a table of FIG. 32. As the user groups, for example, an intellectual property division, and a management division of a business department are respectively classified as the AA and the AB divisions. FIG. 32 defines the agreement information groups that these user groups can access.

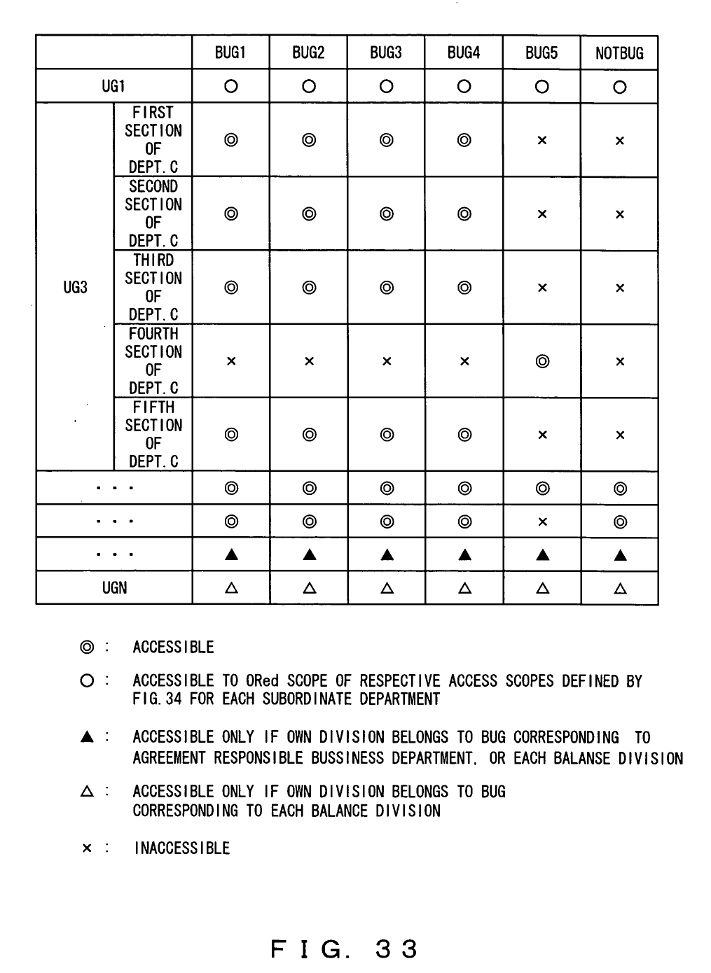

FIG. 33 defines data that are accessible by the user groups, and belong to which divisions. Divisions A, B, C divisions, etc. and their subordinate departments, which are represented as the division data in FIG. 4, respectively correspond to business groups BUGs. Namely, this figure defines that the respective user groups in the left fields can reference data of which business group.

According to FIGS. 32 and 33, an access right is decided by determining whether or not information (data) can be accessed by a person in a certain user group, and whether or not an access can be made to a business group to which the data is relevant.

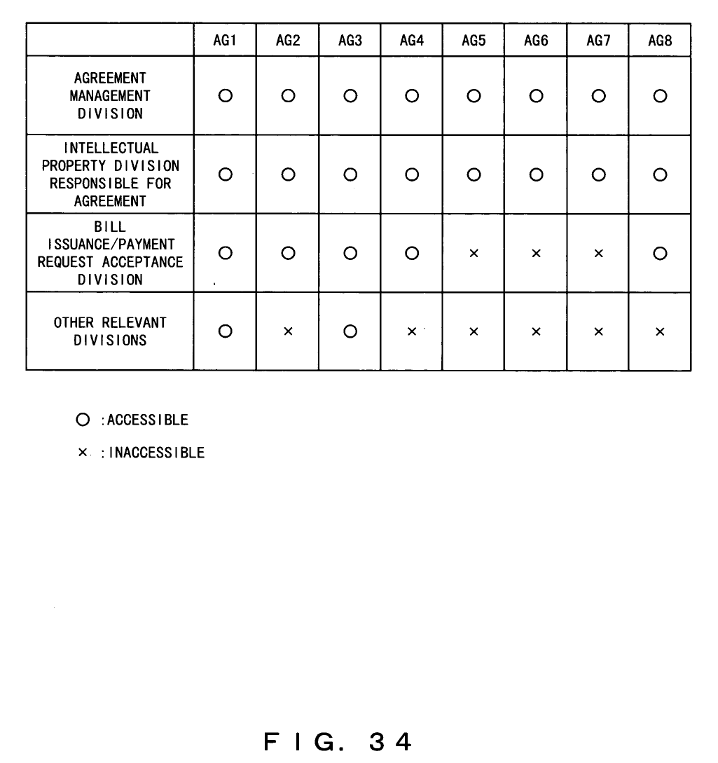

In the meantime, for example, if setting is made to disable a person who is responsible for an agreement in a certain user group to view data possessed by the business groups of FIG. 33, it is necessary to allow the person to make an access by regarding the agreement as an agreement for which the person is exceptionally responsible. Such a mechanism is shown in FIG. 34. The left fields of FIG. 34 indicate a division data item recorded within agreement data, and a horizontal columns indicate the agreement information groups. For example, an agreement management division, an intellectual property division responsible for an agreement, a bill issuance/payment request acceptance division, and other relevant divisions are shown. Whether or not to permit an access right to an agreement information group is determined for a user whose division matches a division stored in the division data items. Namely, even if a user who attempts to access agreement data is restricted by FIGS. 32 and 33, an access to data marked with “?” among data in the right columns is permitted if the user whose division matches a division registered in the agreement data.

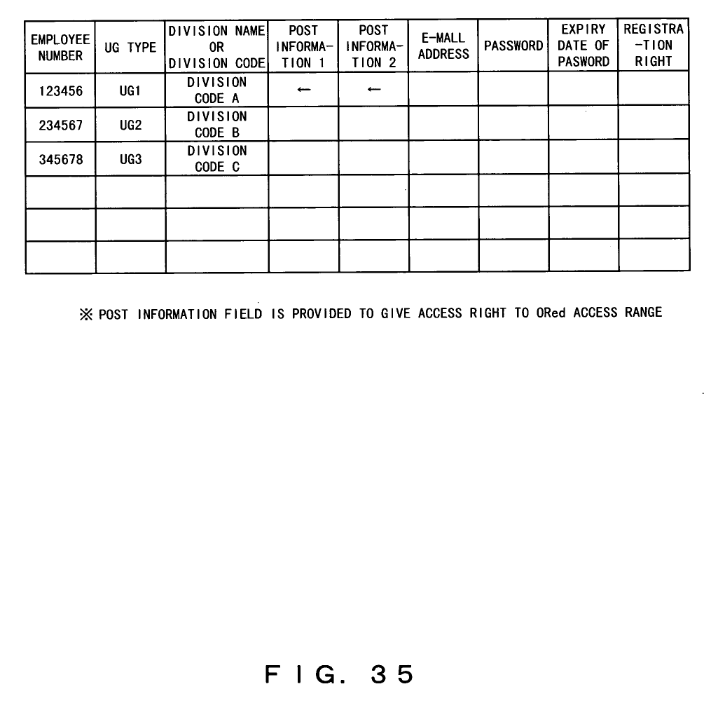

FIG. 35 indicates user data possessed by the agreement management system for users who are permitted by a request to use the system. A user ID (employee number), a user group type, a user division, information of an additional post in a division, an electronic mail address to which notification of term management, etc. is made, a password, a valid term of the password, a registration right, etc. are stored. A person who is permitted to access this system is limited to the persons who are registered to the user data of FIG. 35. Additionally, whether or not a person can access each agreement data item, etc. is determined with the above described determinations of the permission/prohibition of FIGS. 32, 33, and 34 depending on a user group type and a user division (division code) of FIG. 35. A registration right indicates whether or not a user has a right to be able to register agreement data, etc. to the system. This is information that a management division determines at the time of the above described user registration request, and registers to this system. The additional post field allows an access right resultant from a logical OR of access rights of two divisions or more to which a plurality of jobs belong if one person does the plurality of jobs.

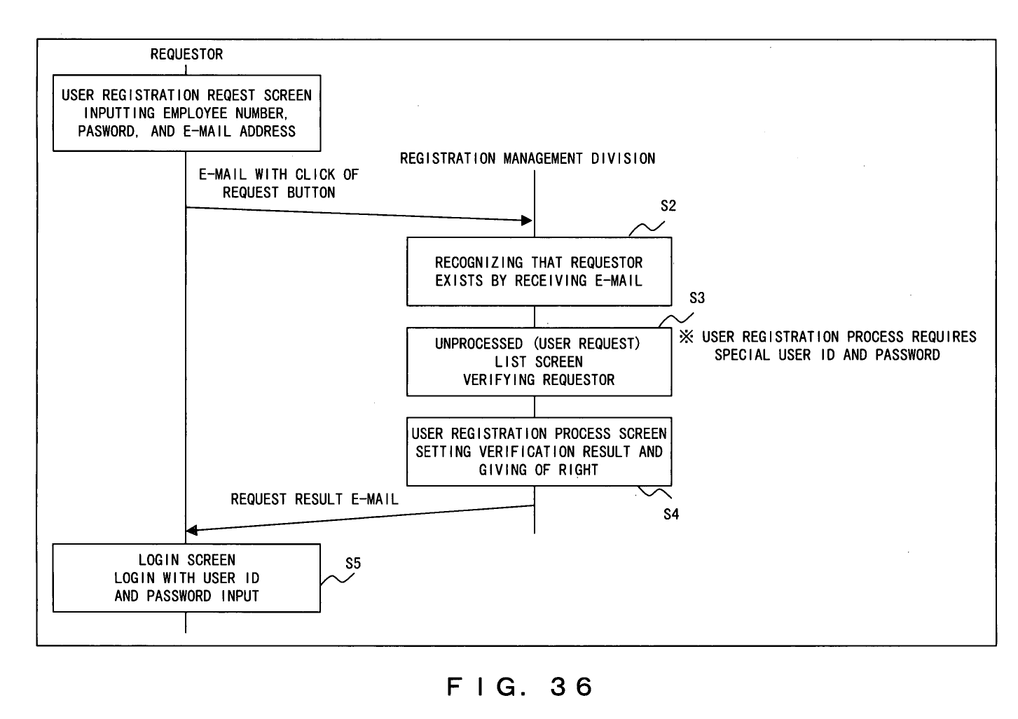

FIG. 36 is a flowchart showing the flow up to user registration.

A requestor first opens a user registration request screen, and inputs an employee number, password, and e-mail information (step S1). With the press of a request button, e-mail is transmitted to a registration management division. The registration management division receives the e-mail, and verifies that the requestor exists (step S2). Next, the registration management division verifies the requester on the unprocessed registration request list screen (step S3). Then, the registration management division sets a verification result, and the giving of a right to use the system (step S4). As is executed by the registration management division in this way, the user registration process is a verification process of a requester who requires a special user ID and password. When the right to use the system is given to the requester in step S4, request result e-mail is transmitted to the requester. The requestor that receives the request result e-mail proceeds to a login screen, on which the requestor inputs the user ID and password to log in to the system.

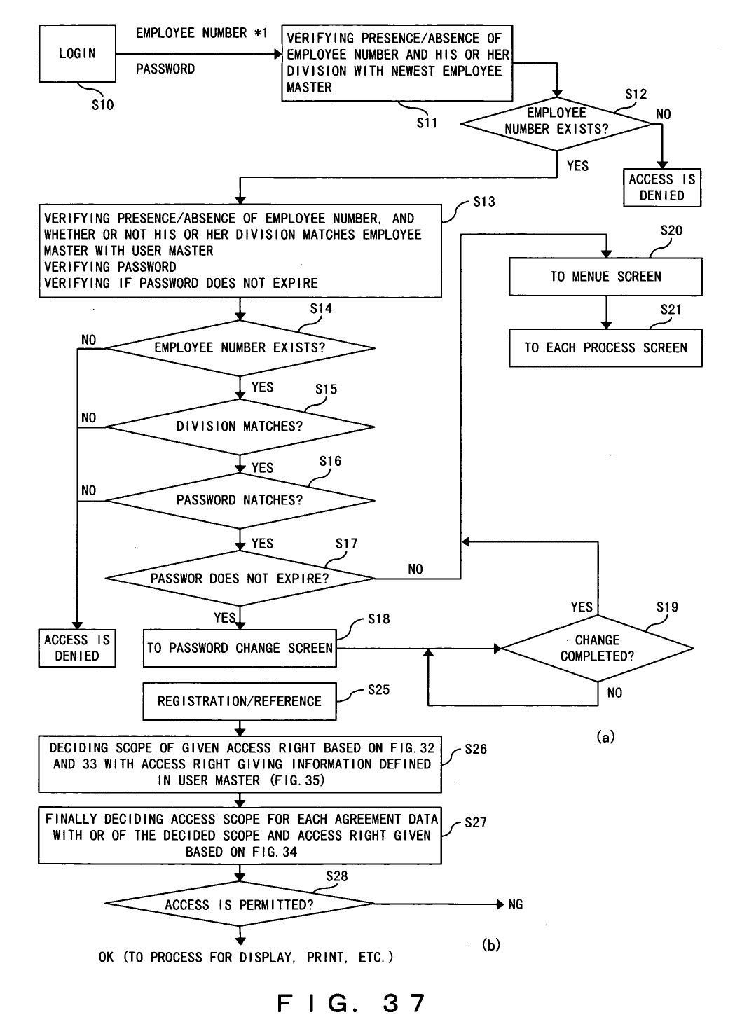

FIG. 37 is a flowchart showing the flow from login to the giving of an access right.

FIG. 37(a) is first described.

When a user logs in to the system with a password, etc. in step S10, the system verifies the presence/absence of an employee number, and an employee division with the newest employee master in step S11. In step S12, if the employee number is determined not to exist, the access is denied. If the employee number is determined to exist, the system verifies, with the user master (FIG. 35), the presence/absence of the employee number, whether or not the user's division matches the employee master, the password, and the valid term of the password in step S13. If the employee number is determined not to exist in step S14, the access is denied. If the employee number is determined to exist, the system determines whether or not the employee division matches in step S15. If the employee division does not match, the access is denied. If the employee division matches, the system further determines whether or not the password matches. If the password does not match, the access is denied. If the password matches, the system determines whether or not the valid term of the password has expired. If the valid term of the password has expired, the display proceeds to the password change screen in step S18, on which the password is changed in step S19, and proceeds to step S20. Also if the valid term of the password does not expire, the flow proceeds to step S20. In step S20, the menu screen is displayed, and the display proceeds from the menu screen to each process screen (step S21).

FIG. 37(b) shows a process for registering/referencing agreement data. Here, assume that a user has an access right to make registration/reference. When a transition is made from the menu screen to a registration/reference process screen (step S25), the scope of a given access right based on FIGS. 32 and 33 is decided according to the access right giving information defined in the user master in step S26. In step S27, the access right is finally decided based on the scope decided in step S26, and its logical OR with the access right given based on FIG. 34. Then, in step S28, whether or not to permit an access is determined. If the access is rejected in S28, the user cannot make the access. If the access is permitted in step S28, the flow proceeds to a process such as display, printing, etc. of agreement data.

Statistical Data

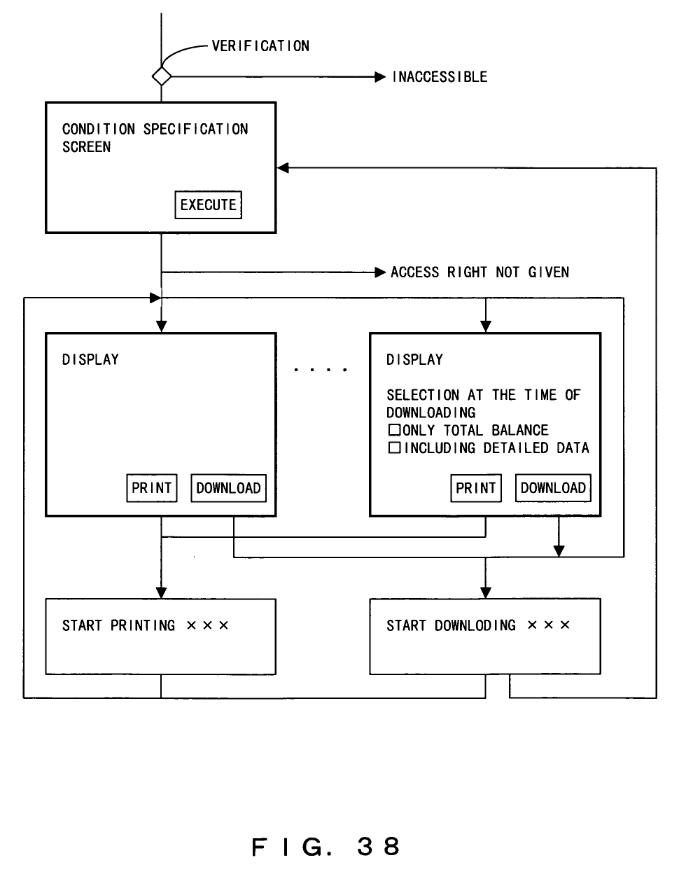

FIGS. 38 to 42 exemplify screens relevant to statistical data.

FIG. 38 shows the state of a screen transition of a statistical output.

When a user first attempts to make an access to statistical data, whether or not to permit the access is verified based on an access right of the user. If the access is not permitted, the access is denied. If the access is permitted, the display proceeds to the condition specification screen. The user specifies his or her desired statistical data, and clicks a button to execute a statistical process on the condition specification screen. If the statistical data includes data for which the user does not have an access right, the data is not displayed due to the absence of the access right also at this time. If the access right of the user covers the entire statistical data, it is output in accordance with the specified process. The display can include a plurality of pieces of statistical data. The user can print or download the data. Additionally, a selection to make statistical data include a balance total or detailed data, etc. is enabled depending on the type of statistical data as a selection at the time of data downloading.

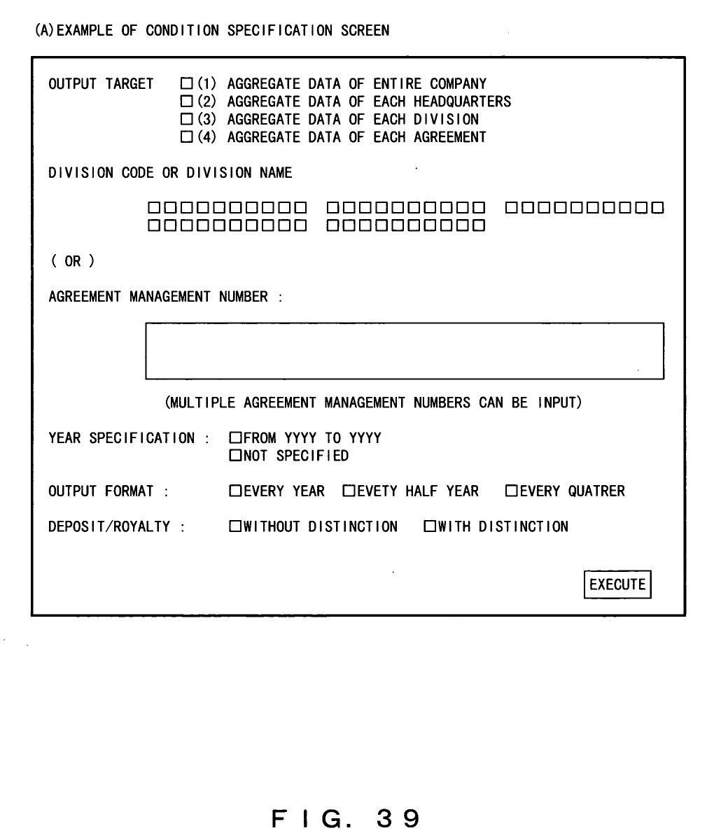

FIG. 39 exemplifies the condition specification screen.

As output targets, aggregate data of an entire company, aggregate data of each headquarters, aggregate data of each division, and aggregate data of each agreement are provided. A division code or name is used to specify the aggregate data of each division. An agreement management number is specified when the aggregate data of each agreement is obtained. Additionally, year specification, an output form, a distinction between a deposit and a running royalty, or the like can be specified. These items are specified, and an execution button is clicked, so that specified statistical data is displayed.

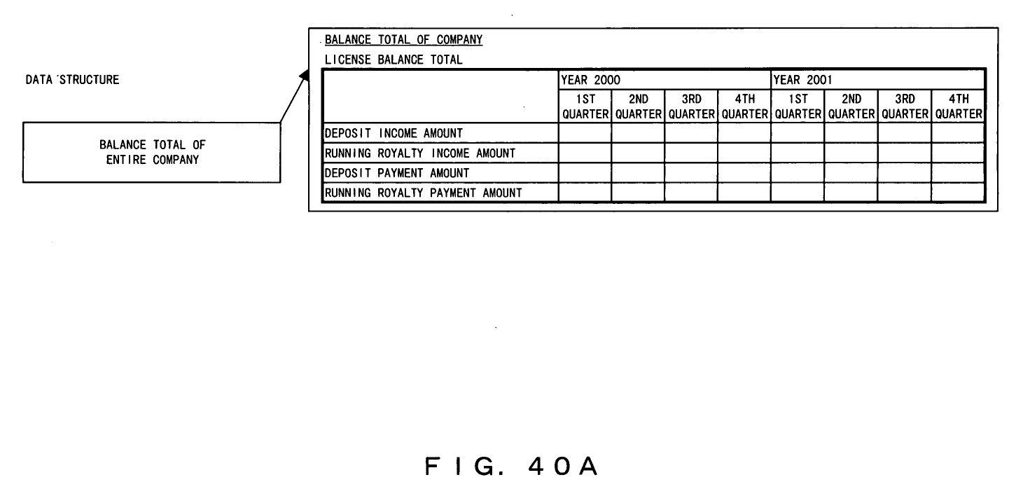

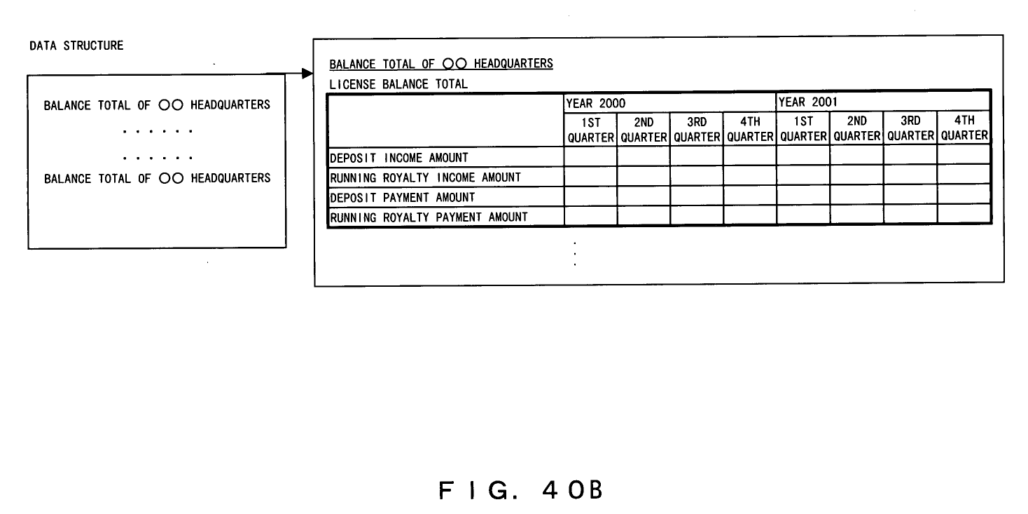

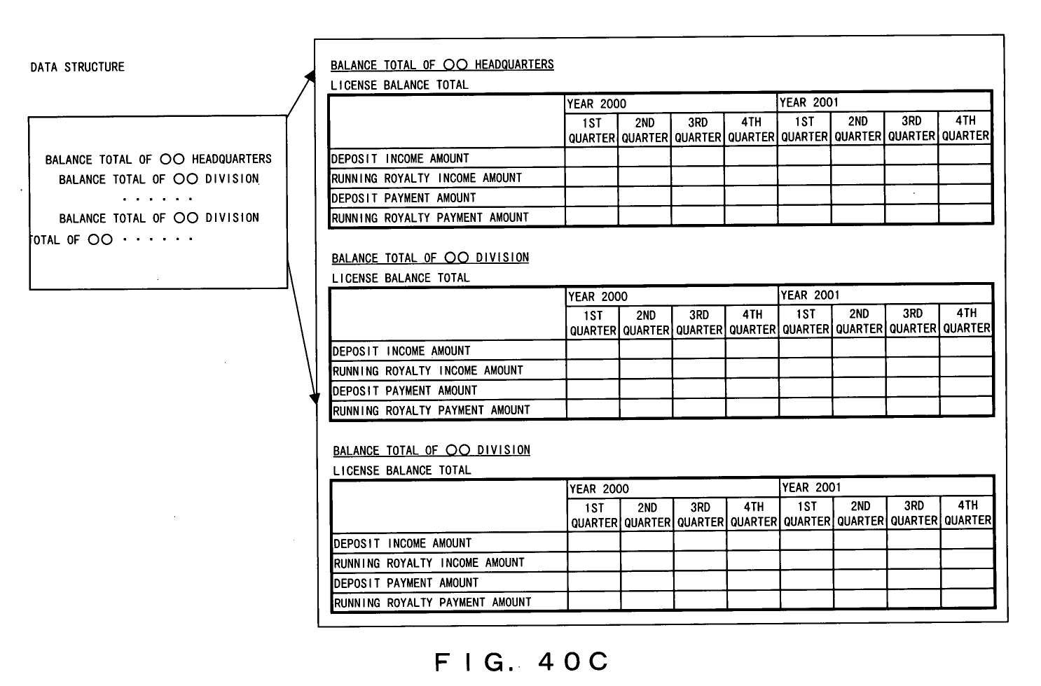

FIGS. 40 to 42 exemplify statistical output data formats.

In a balance total of an entire company shown in FIG. 40A, a total of deposit income amounts, a total of running royalty income amounts, a total of deposit payment amounts, and a total of running royalty payment amounts are represented for each quarter of each year for the entire company.

FIG. 40B shows the data of each headquarters, and a plurality of headquarters are enumerated. With the click of one of the headquarters, a license balance of the specified headquarters is represented for each quarter of each year. FIG. 40C shows the data of each division, and a plurality of divisions are enumerated. In this case, the balance total of the headquarters, and the balance total of licenses of each division are displayed in a similar manner.

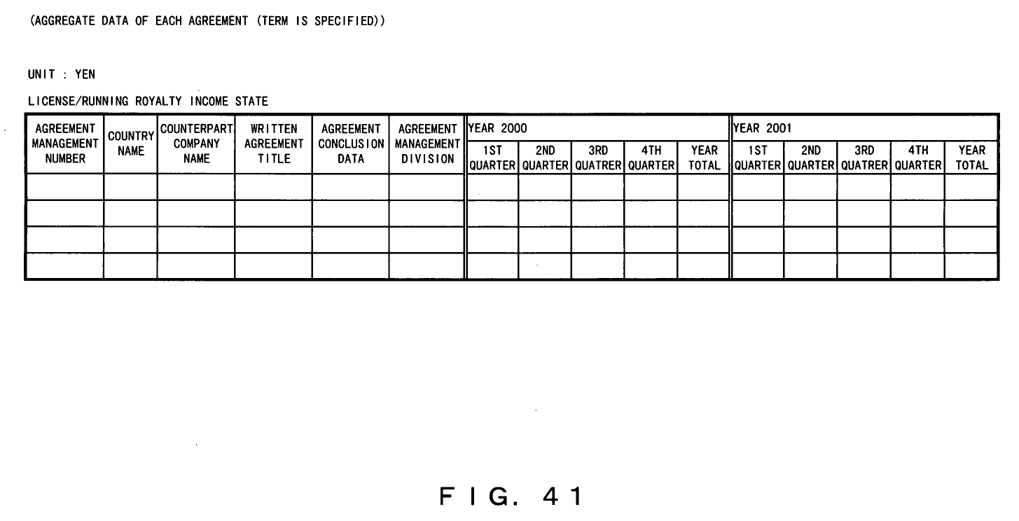

FIG. 41 exemplifies a display format in the case where a term of the aggregate data of each agreement is specified.

In this format, expenditure data is represented in the same arrangement under income data. Additionally, if a distinction between home and abroad is not made, the data is collectively displayed as one table. For only home or abroad, the data of only home or abroad is output. If the data is output without making a distinction between a deposit and a running royalty, the data is collected in one table, in which a combined amount is displayed.

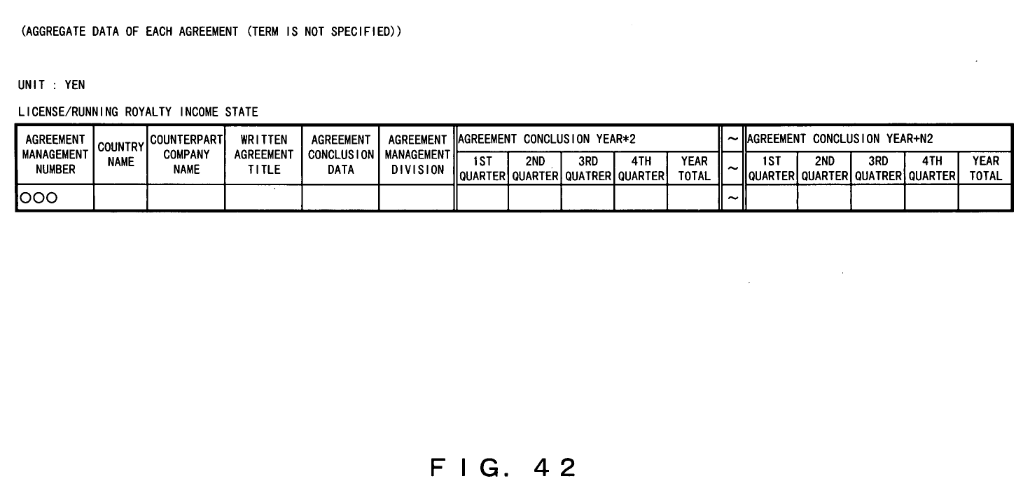

FIG. 42 exemplifies a display format in the case where a term is not specified in aggregate data of each agreement.

In this case, the data is displayed in an order of specified agreement management numbers when the agreement management numbers are specified. In the case of a division code search, the data is displayed in an order of agreement management numbers. Since a term is not specified in this case, all of the effective agreements are displayed.

Control of operations of the agreement management system according to the present invention is described below with reference to flowcharts.

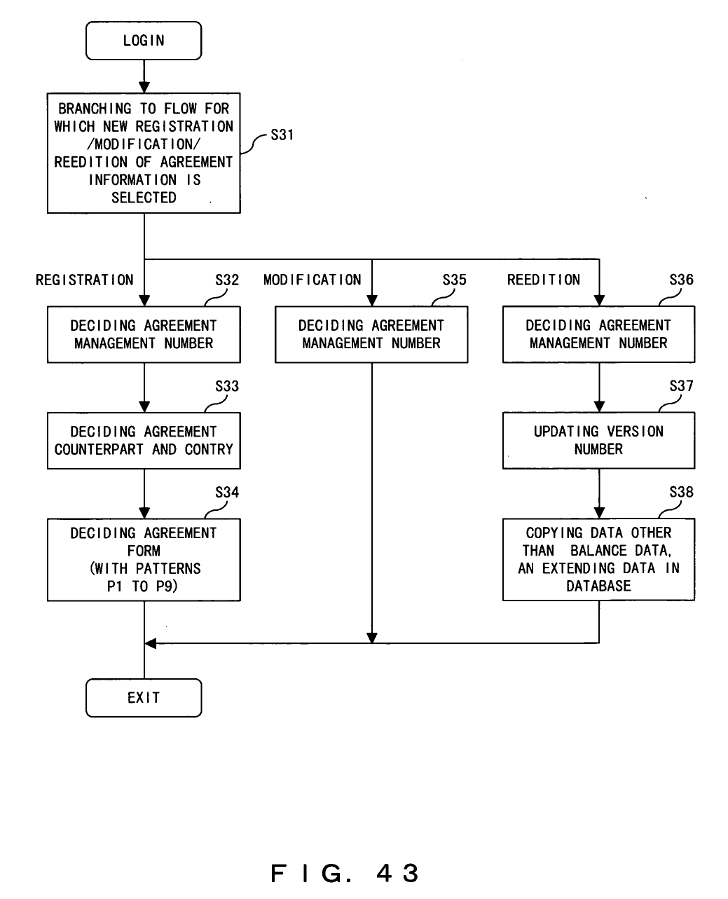

FIG. 43 is a flowchart showing a registration/modification/reedition process starting from login. The reedition is used as the following meaning.

Reedition/Version Number

If contents of an agreement are changed with a memorandum of understanding for one agreement, contents obtained by incorporating an article changed with the memorandum in the contents of the agreement, which is the base, is defined to be a reedition.

To register data of a memorandum of understanding, reedition is specified on the initial screen, the management number of the agreement, which is the base, is input, and contents of a change are input to a correction memorandum field, for example, by being itemized.

At the time of reedition, the version number of the agreement management number is automatically updated by the system.

Assume that memoranda of understanding are exchanged twice, and their contents are added. In this case, the version number of the agreement management number, which is originally the agreement “0000-01” (the first edition), is updated to an agreement “0000-02” (the second edition) when the first memorandum of understanding is added, and further updated to an agreement “0000-03” (the third edition) when the second memorandum of understanding is added.

Firstly, in step S31, the process branches to a route for which new registration, modification, or reedition of agreement information is selected. In the case of new registration, the process proceeds to step S32, in which an agreement management number is decided. Then, in step S33, an agreement counterpart and a country are decided. In step S34, an agreement form is decided. An agreement form is decided with the patterns P1 to P9 of FIG. 11. In the case of modification, an agreement management number is decided in step S35. In the case of reedition, an agreement management number is decided in step 36. Then, in step S37, a version number is updated. In step S38, data other than balance data is copied and extended in a database.

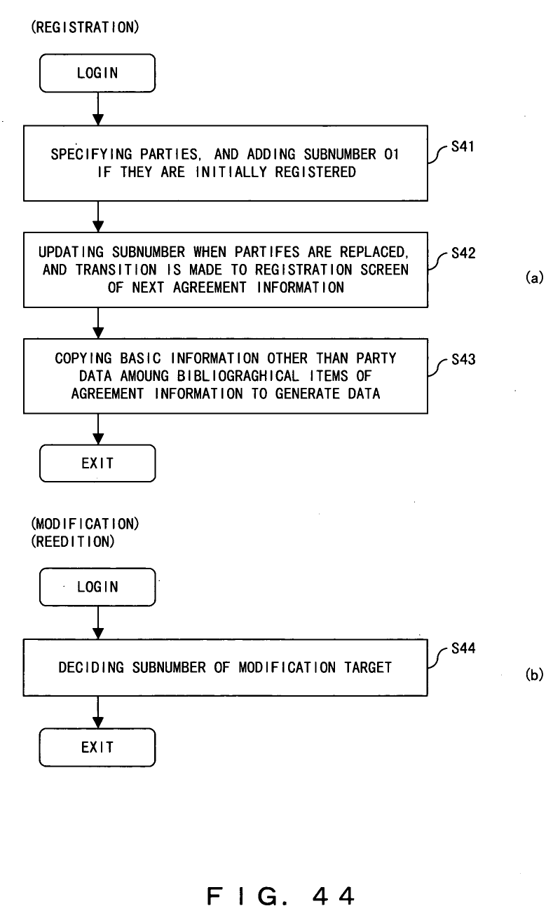

FIG. 44 is a flowchart showing a subnumber process.

In the following cases, the system adds a subnumber as a virtually separate agreement, and manages the agreements.

(1) Case where a consideration income and a consideration payment are mutually made between the same parties in one agreement.

(2) Case where a party (licensor) of this system grants a plurality of agreement parties (licensees) a license in one agreement.

(3) Case where a license is granted from a plurality of agreement parties (licensors) to a party (licensee) of this system in one agreement, and a consideration payment is incurred for each of the plurality of parties.

FIG. 44(a) shows a subnumber process at the time of registration. In step S41, parties are specified, and a subnumber 01 is added if the parties are initially registered. In step S42, the parties are exchanged, and a subnumber is updated when a transition is made to a screen on which the next agreement information is registered. In step S43, the bibliographical items of the agreement information other than the party data of the basic information are copied to generate data.

FIG. 44(b) shows a subnumber process in the case of modification and reedition. Especially, in the case of reedition, also data to which a subnumber is added is copied in step S38 of FIG. 43. As the subnumber process at the time of modification or reedition, only a process for deciding a subnumber of a modification target is executed as indicated by step S44. If the system is not built as a system which supports a subnumber, the control shown in FIG. 44 is unnecessary.

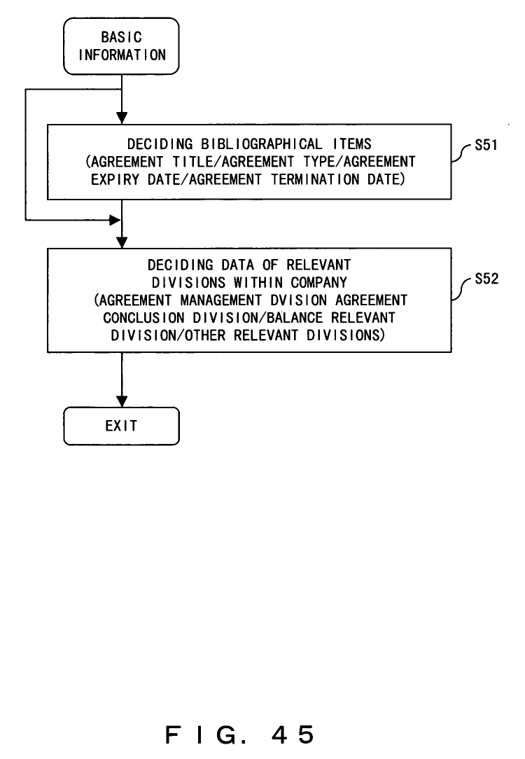

FIG. 45 is a flowchart showing a process for registering basic information.

In step S51, the system decides bibliographical items among basic information. The bibliographical items include an agreement title, an agreement type, agreement parties, an agreement conclusion date, an agreement term, an agreement expiry date, an agreement termination date, etc. In step S52, data of relevant divisions within a company is decided. Examples of the relevant divisions include an agreement management division, an agreement conclusion division, a division relevant to a balance, other relevant divisions, etc. The flow of FIG. 45 is the process activated when “bibliographical items” or “relevant division within a company” of the basic information is clicked on the screen of (5) of FIG. 12. This process is intended to register bibliographical items and relevant divisions respectively. Accordingly, with the click of the “bibliographical items”, which are the contents of the basic information, the bibliographical items are input, and then the process moves to an input of the relevant divisions within the company. Additionally, with the click of “relevant divisions within a company” of the basic information, a screen for registering relevant divisions within a company is displayed. When the registration of the relevant divisions within the company is terminated, the display returns to (5) of FIG. 12. If a bibliographical item is desired to be registered after the relevant divisions within the company are registered, the “bibliographical items” is clicked after the display returns to (5) of FIG. 12, and the bibliographical item is input.

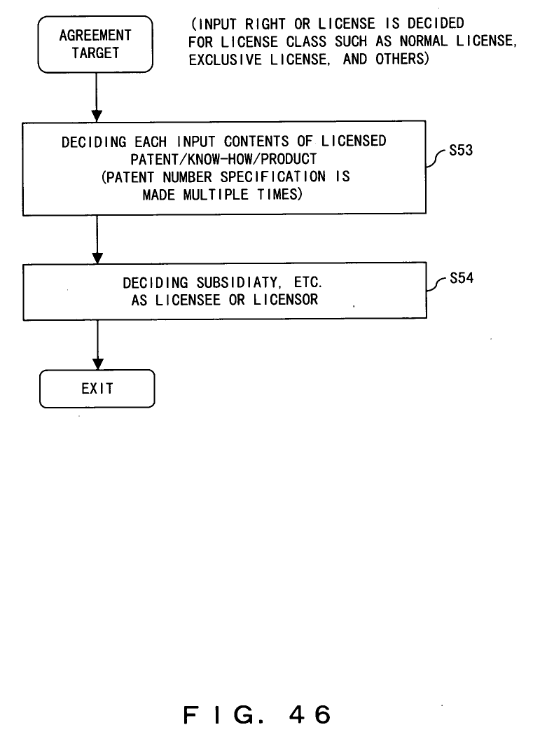

FIG. 46 is a flowchart showing a process for registering data of an agreement target.

At the time of the data registration of an agreement target, an input right, license, etc. is decided for each form of permitted right classification (normal license, exclusive license (or exclusive right), etc.). In step S53, contents of each input of a licensed patent/know-how/product are decided (patent number specification is repeatedly made by the number of patent numbers to be specified). In step S54, a subsidiary, etc. are decided as a permittee/permitter.

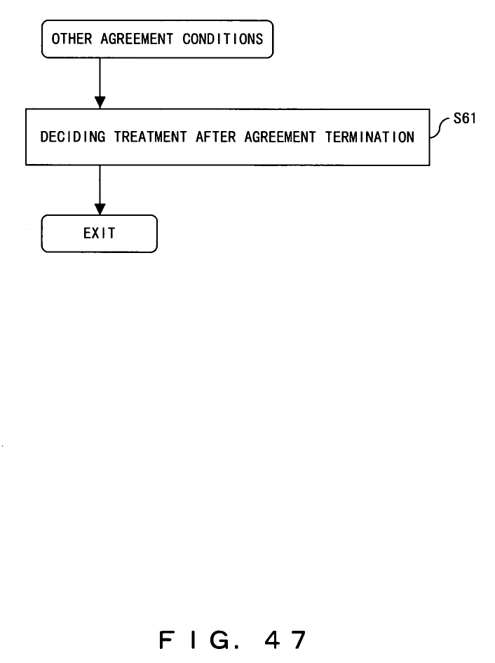

FIG. 47 is a flowchart showing a process for setting other agreement conditions.

In step S61, how to treat an agreement after termination of the agreement is decided, and the process is completed.

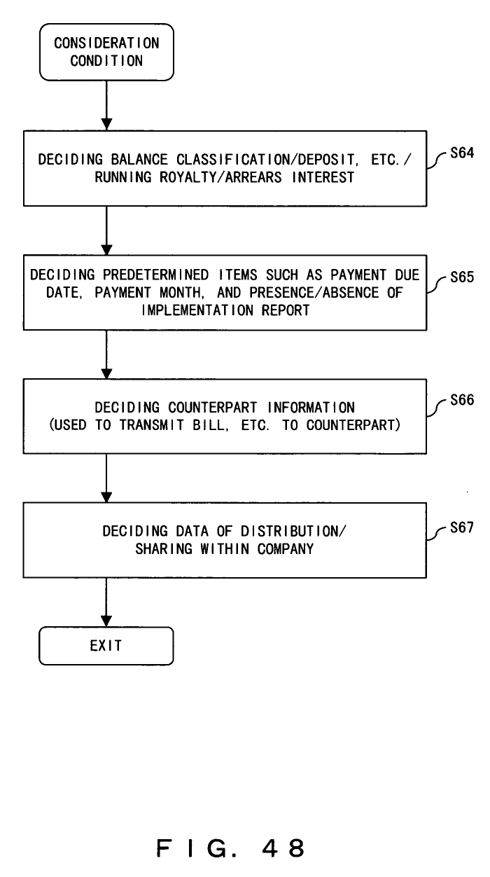

FIG. 48 is a flowchart showing a process for setting consideration conditions.

In step S64, balance classification/a deposit, etc./running royalty/an arrears interest are decided. In step S65, predetermined items such as a payment due date, a payment month, and the presence/absence of an implementation report (such as royalty report), etc. are decided. Then, in step S66, counterpart information is decided. This information is used to transmit a bill, etc. In step S67, data of distribution/sharing within a company is decided, and the process is completed.

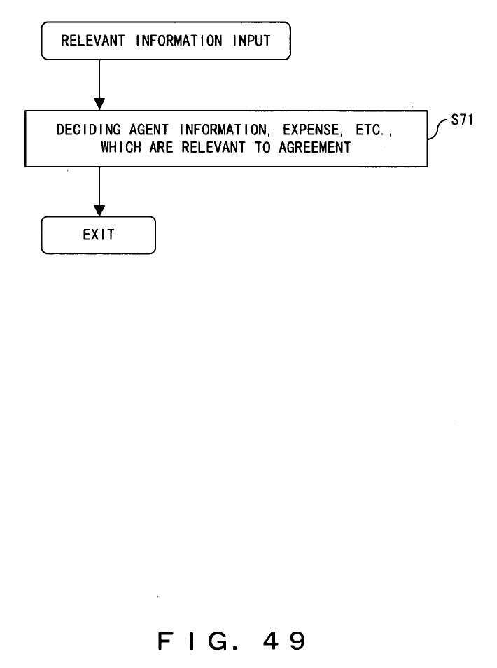

FIG. 49 is a flowchart showing a process for inputting relevant information.

Relevant information can be input with the click of an “agent” button in (5) of FIG. 12. When an input format is displayed, information of an agent involved in an agreement, expenses, etc. are decided. This process is similar also when written agreement data is modified. At the time of modification, registered data is displayed, contents are decided after being modified with overwriting, and the data is reflected on the system.

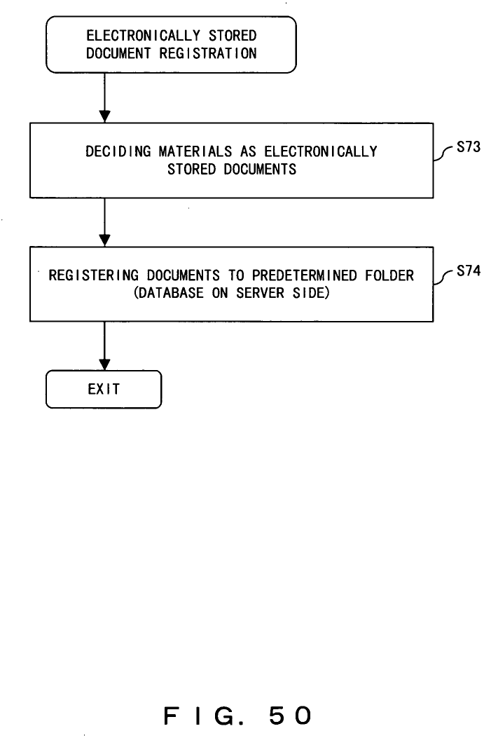

FIG. 50 is a flowchart showing a process for registering an electronically stored document.

In the electronically stored document registration process, a document is decided as an electronically stored document in step S73. Instep S74, the electronically stored document is registered to a predetermined folder (registered to a database on the server side) in step S74, and the registration is completed.

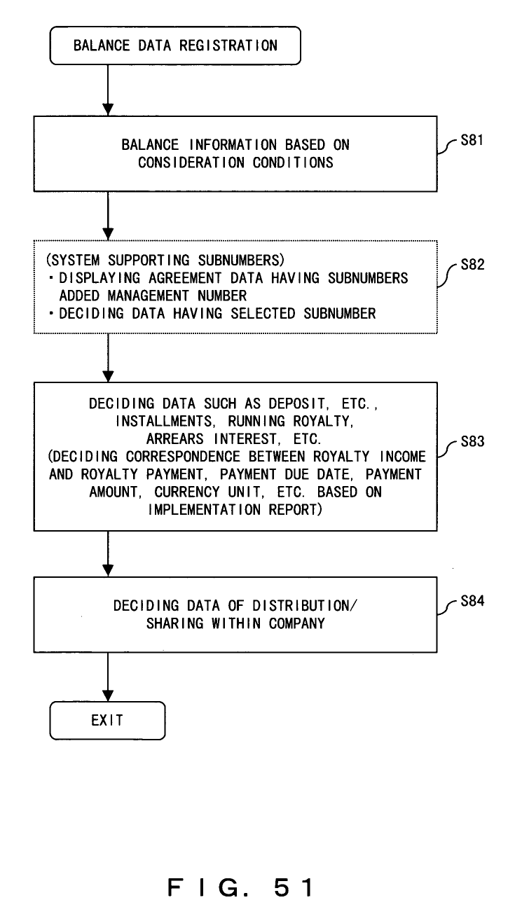

FIG. 51 is a flowchart showing a process for registering balance data.

Firstly, in step S81, an input screen of balance information based on consideration conditions is displayed. Step S82 is applied to the case where agreement data is managed with a subnumber. Namely, data with a subnumber, which is added to a management number, is displayed. Additionally, data of a selected subnumber is decided. In step S83, data of a deposit, etc., installments, a running royalty, an arrears interest, etc. are decided. Especially, a correspondence between an income and a payment of a running royalty, a payment due date, a payment amount, a currency unit, etc. are decided. Then, in step S84, data of distribution/sharing within a company is decided, and the registration is completed. Contents of the registered balance data are reflected on data including balance data of an agreement original, and on data downloaded as CSV data.

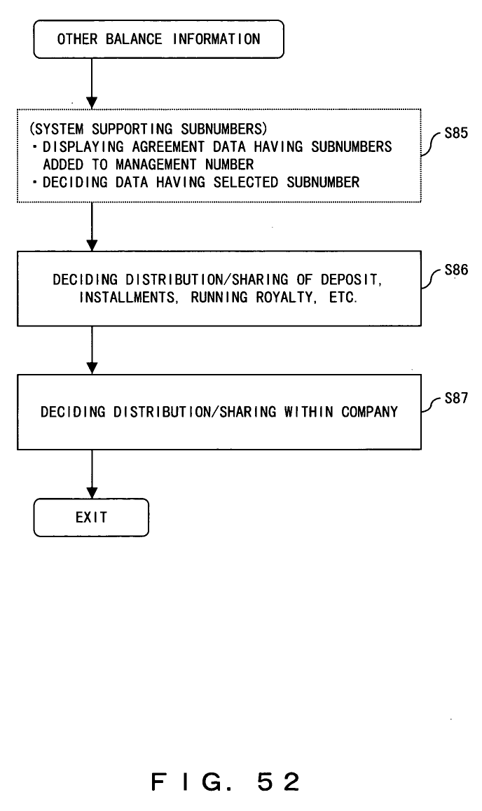

FIG. 52 is a flowchart showing a process for registering other balance information. The other balance information includes the following.

Other Balance (Installments)

If distribution/sharing within a company is made for installments as a consideration of an agreement, its balance data is input.

Other Balance (Running Royalty)

If distribution/sharing within a company of a running royalty incurred is made, its balance data is input.

Other Balance (Lump Sum)

If distribution/sharing within a company of a deposit incurred when or after an agreement is concluded is made as a consideration in an agreement, its balance data is input.

Additionally, for example, if a transfer expense is received in accompaniment with a transfer agreement, or if money is received as a transfer penalty charge for an agreement which does not incur a consideration (such as a no-consideration license agreement, no-consideration cross agreement, etc.), distribution/sharing within a company is input if it is made.

Description is provided with reference to FIG. 52. In step S85, if an agreement is managed with subnumbers, data of the subnumbers added to a management number is displayed, and data of a selected subnumber is decided. In step S86, distribution/sharing of a deposit, installments, a running royalty, etc. is decided. In step S87, the distribution/sharing within a company is decided, and the registration is completed.

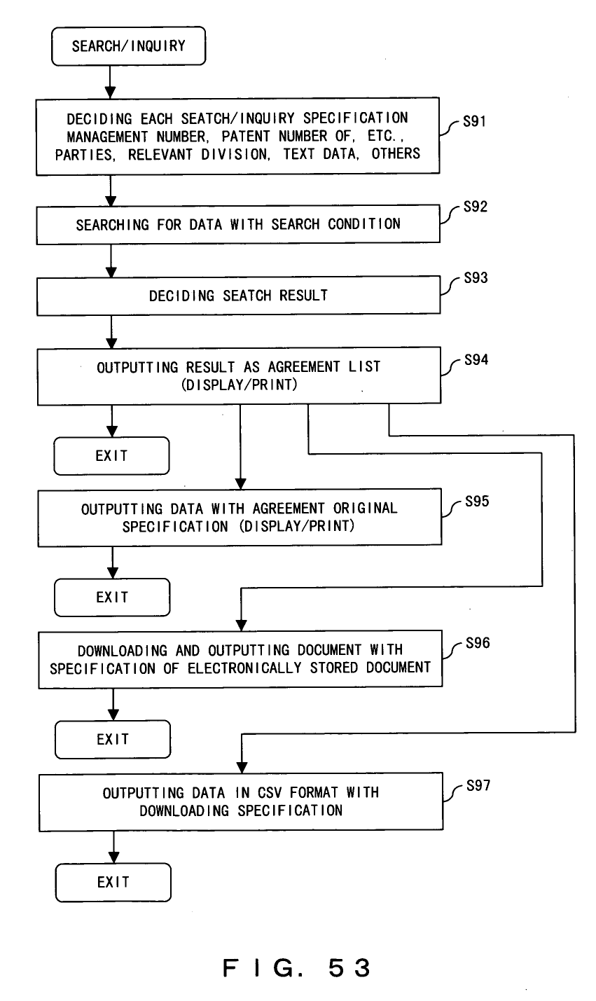

FIG. 53 is a flowchart showing a search/inquiry process.

Firstly, in step S91, specification of each search/inquiry is decided. For each search/inquiry, a management number, a number of a patent, etc., a party, a relevant division, text data, etc. are specified. In step S92, the system makes a data search with a search condition. In step S93, a search result is decided. In step S94, the search result is output as an agreement list. This output is made by being displayed on the display unit, or by being printed on a paper medium. Then, as described with reference to FIG. 8, the process is completed with a user instruction, the process is completed after making an output (display/print) by specifying an agreement original (step S95), the process is completed after downloading and outputting a document with electronically stored document specification (step S96), or the process is completed after outputting data in a CSV format with downloading specification (step S97). In step S94, all pieces of data having the same management number to which subnumbers are respectively added are output if the data is managed with the subnumbers. This is similar also for an agreement original output.

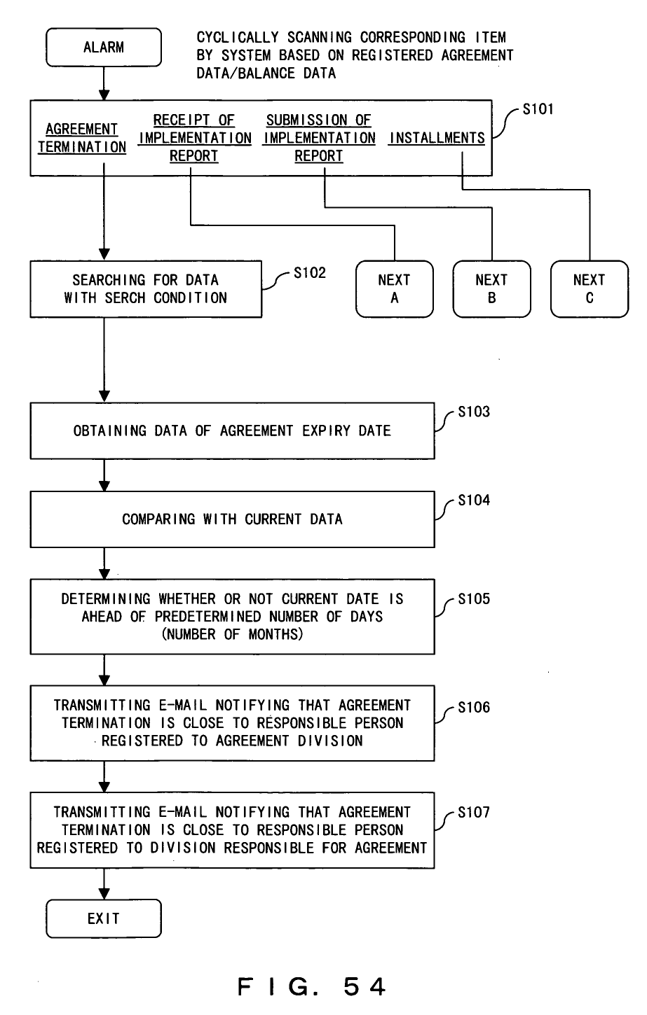

FIG. 54 is a flowchart showing an alarm process.

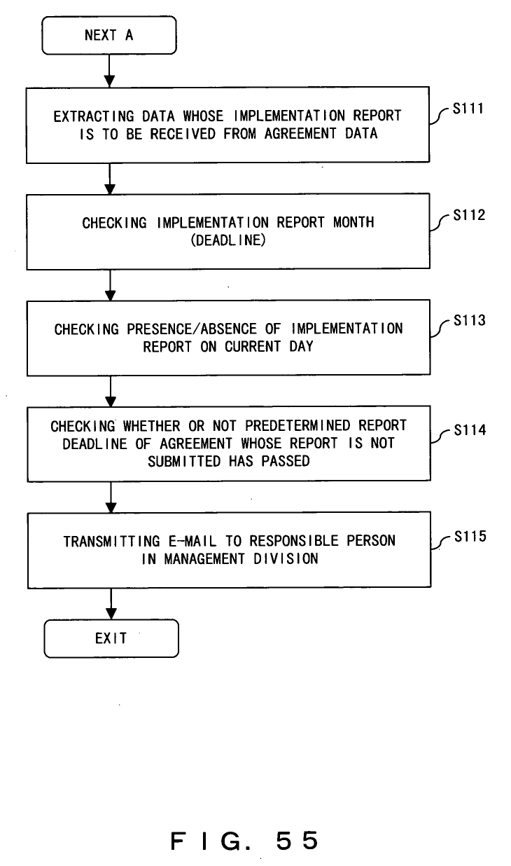

Firstly, the system cyclically scans a corresponding item based on registered agreement data and balance data. Then, in step S101, a process for an agreement termination, implementation report (such as royalty report) receipt, implementation report (such as royalty report) submission, or installments is executed. The implementation report (such as royalty report) receipt process, the implementation report (such as royalty report) submission process, and the installments process respectively succeed to the flowcharts shown in FIGS. 55, 56, and 57. In the case of the agreement termination, an agreement termination schedule is automatically notified in step S102. In step S103, data of an agreement expiry date is obtained. In step S104, a comparison is made between the current date and time and the agreement expiry date. In step S105, it is determined whether or not the agreement expiry date is ahead of the current date by a predetermined number of days (or a predetermined number of months) In step S106, an e-mail notifying that the agreement termination is close is transmitted to a responsible person registered to an agreement management division. In step S107, e-mail notifying that the agreement termination is close is transmitted to a responsible person registered to a division responsible for the agreement.

FIG. 55 is a flowchart showing an alarm process for the receipt of an implementation report (such as royalty report).

In step S111, implementation report (such as royalty report) data to be received is extracted from agreement data. In step S112, the system checks an implementation report (such as royalty report) month (deadline). In step S113, the system checks the current date and time, and the presence/absence of an implementation report (such as royalty report). Then, in step S114, the system checks whether or not a predetermined deadline of data whose implementation report (such as royalty report) has not been received yet has passed. Instep S115, the system transmits e-mail to a responsible person in a management division.

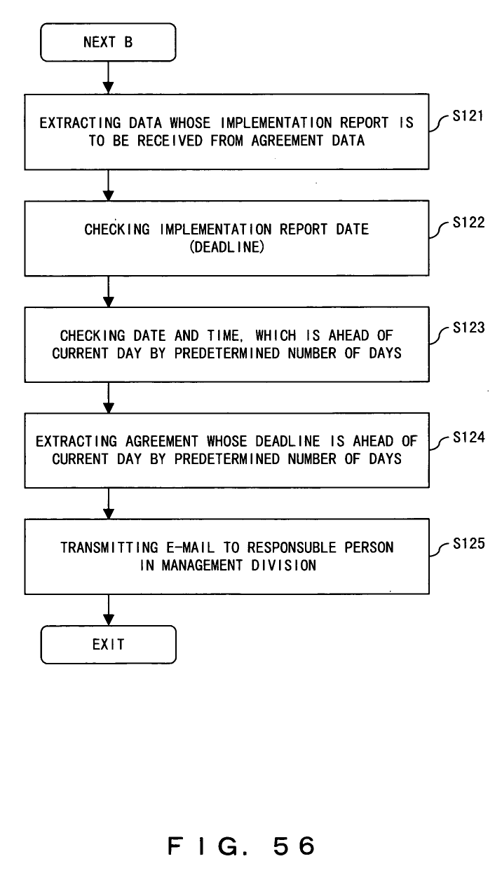

FIG. 56 is a flowchart showing an alarm process for the submission of an implementation report (such as royalty report).

In step S121, implementation report (such as royalty report) data to be submitted is extracted from agreement data. In step S122, the system checks an implementation report (such as royalty report) month (deadline). In step S123, the system checks a date and time, which is ahead of the current day by a predetermined number of days. In step S124, the system extracts an agreement whose deadline is ahead of the current day by the predetermined number of days. In step S125, e-mail for calling attention to the extracted agreement is transmitted to a responsible person in a management division.

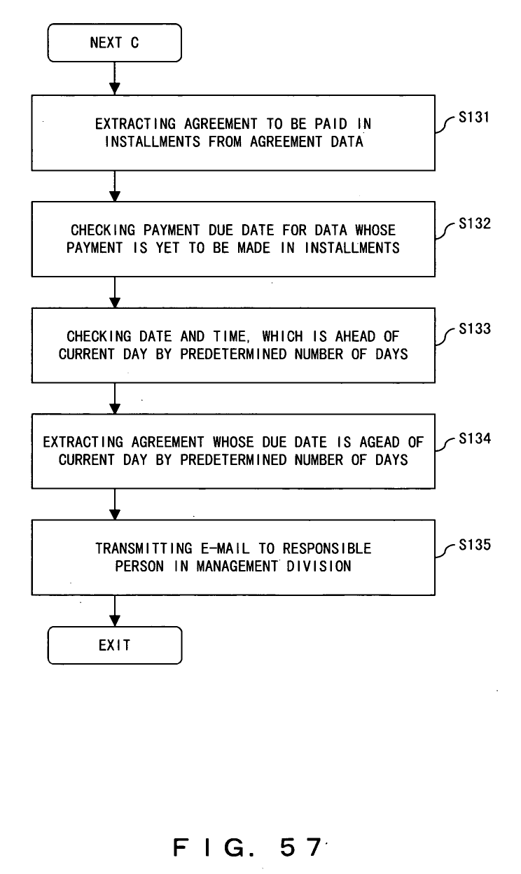

FIG. 57 is a flowchart showing an alarm process for installments. This figure assumes the case where a company on this side receives installments money.

In step Sl31, an agreement to be paid in installments is extracted from agreement data. Instep S132, a payment due date is checked for data yet to be paid in installments. In step S133, a date and time, which is ahead of the current date and time by a predetermined number of days, is checked. In step S134, an agreement whose due date is ahead of the current day by the predetermined number of days is extracted. In step S135, e-mail for calling attention is transmitted to a responsible person in a management division. E-mail for notifying that a payment due date is close is transmitted to a management division on a date and time, which is ahead of a payment due date by a predetermined number of days also when the company on this side pays an installment.

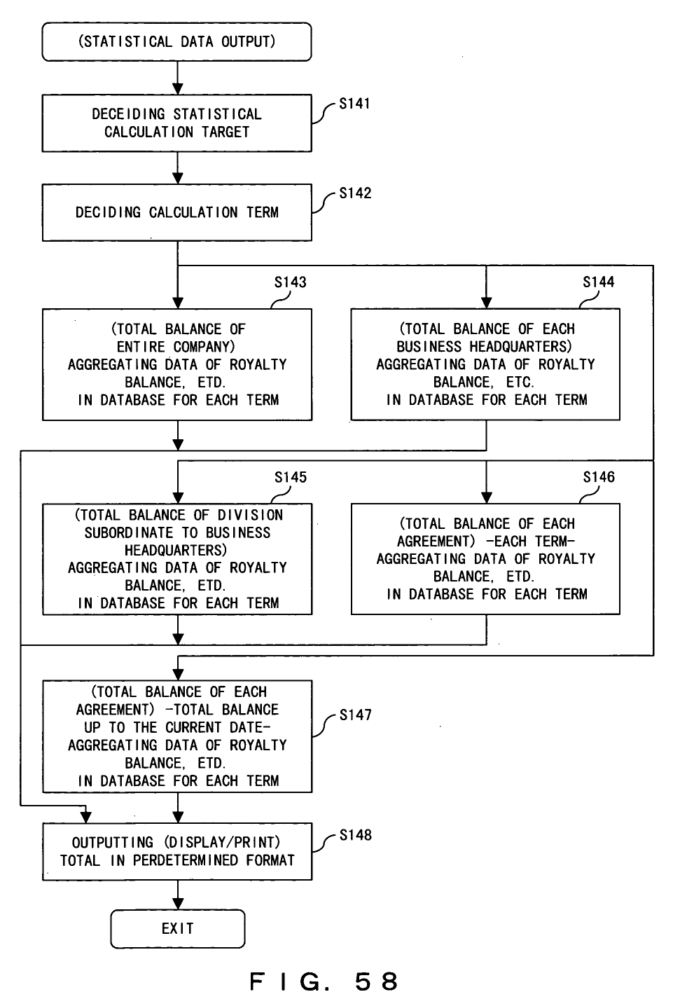

FIG. 58 is a flowchart showing a process for statistical data.

Firstly, in step S141, a statistical calculation target is decided. In step S142, a calculation term is decided. A term is not specified in some cases. Thereafter, the process branches according to a user instruction. If the user instructs the total balance of an entire company, data of a royalty balance, etc. in the database is added and aggregated for each term in step S143. The aggregated data is output (displayed/printed) in a predetermined format in step S148. If the user instructs the balance total of each business headquarters, data of a royalty balance, etc. in the database is added and aggregated for each term in step S144. Then, the aggregated data is output in step S148. If the user instructs the balance total of each division subordinate to a business headquarters, data of a royalty balance, etc. in the database is added and aggregated in step S145. Then, the aggregated data is output in step S148. If the user instructs the balance total of each agreement for each term, data of a royalty balance, etc. in the database are added and aggregated for each term in step S146. Then, the aggregated data is output in step S148. If the user instructs the total balance of each agreement up to the current time, data of a royalty balance, etc. in the database is added and aggregated in step S147. Then, the aggregated data is output in step S148.

According to the present invention, various agreements or information (documents) of agreements, etc., which spread over divisions, can be managed in common without lowering the level of security, and agreement data and balance data can be provided to a user on demand.

What is claimed is:

1. An agreement management system providing a management number for uniquely identifying each of a plurality of agreements, and managing the plurality of agreements, comprising:
a unit respectively stipulating a payer side and a payee side as a licensee (or a transferee, etc.) and a licensor (or a transferor, etc.) in case of an agreement which incurs payments mutually between agreement parties, regarding the plurality of agreements respectively as independent agreements, individually assigning management numbers to the agreements, and registering the agreements.

2. The agreement management system according to claim 1, wherein
said unit regarding the plurality of agreements respectively as the independent agreements, individually assigning the management numbers, and registering the agreements regards the agreements to which the management numbers are individually assigned as one group, and executes a registration process by including information of the group in the management numbers.

3. The agreement management system according to claim 1, wherein
said unit regarding the plurality of payments respectively as the independent agreements, individually assigning the management numbers, and registering the plurality of agreements adds an additional number (subnumber) to the management numbers, and executes a registration process.

4. An agreement management system, comprising:
an agreement data registering unit classifying information about an agreement as any of basic information such as party data, etc., an agreement target, agreement conditions such as a consideration, etc., and balance data of a running royalty, etc., each of which is regarded as a data registration unit, regarding each data item of the basic information, the agreement target, and the agreement conditions as a group, and registering the group as agreement data; and
a balance data registering unit registering the balance data, wherein
the agreement data and the balance data are stored in an agreement database by said agreement data registering unit and said balance data registering unit.

5. The agreement management system according to claim 4, further comprising:
a unit processing data of a money amount, which is handled as balance data incurred by an agreement, is processed in a currency unit of a money amount of an income or an expenditure, adding an exchange rate, and registering the money amount.

6. The agreement management system according to claim 4, wherein
said balance data registering unit has a function for registering data distributed to or shared by a third party other than agreement parties for data of an income or payment money amount.

7. The agreement management system according to claim 4, comprising:
a relevant division registering unit registering data of an income or an expenditure stipulated by a consideration condition, which is one item of agreement information, as distribution information or sharing information among relevant divisions within a company.

8. The agreement management system according to claim 4, further comprising:
a unit extracting an income amount or an expenditure amount from the balance data relevant to the agreement, and respectively aggregating and outputting an income amount and an expenditure amount for a running royalty balance of one or more agreements selected with specification in a predetermined term.

9. The agreement management system according to claim 6, further comprising:
a unit calculating and outputting a running royalty balance including income distribution or expenditure sharing, when balance data of a running royalty, etc. of one or more agreements is statistically processed.

10. The agreement management system according to claim 7, further comprising:
a unit processing a statistical balance of a running royalty etc. from registered agreement information for each division involved in agreement information.

11. An agreement management system, comprising:
a database classifying information about an agreement into bibliographical data such as agreement conditions, etc., balance data, and electronic data such as image data and document data, and storing the data;
a server device writing/reading each item of the data to/from said database, and performing control such as form creation, etc.; and
one or more client devices, which are connected to said server device, making registration/modification, or search/inquiry of agreement information, wherein
said server device and said client devices are connected via a network.

12. The agreement management system according to claim 4, further comprising:
a notifying unit notifying a user of every deadline such as an agreement expiry date, an update deadline, an implementation report deadline, an installment payment due date, etc., at a predetermined time point.

13. The agreement management system according to claim 12, wherein
said notifying unit makes a notification to a responsible division via e-mail.

14. The agreement management system according to claim 4, further comprising:
a unit registering presence/absence and abortion/resume of an implementation report registered in accompaniment with a consideration condition, which is part of agreement information.

15. The agreement management system according to claim 4, further comprising:
a unit registering agent information and its expense, etc. as one item of information about an agreement.

16. The agreement management system according to claim 15, further comprising:
a unit calculating balance data by adding the expense in a balance data statistical process.

17. An agreement management system registering information about a plurality of agreements, and making a search or an inquiry for a predetermined agreement, comprising:
a unit registering data of presence/absence of a predetermined article included in a written agreement exchanged by concluding an agreement;
a unit registering a corresponding provision in the written agreement if the predetermined provision exists; and
a unit displaying the provision preregistered in the agreement data obtained as a search result.

18. The agreement management system according to claim 4, further comprising:
a unit searching for corresponding agreement data by selecting a predetermined item from among data of various registered agreements, and outputting searched data.

19. The agreement management system according to claim 18, further comprising:
a unit searching for a data portion input as a document (text) in a traverse manner among agreement data and balance data.

20. An agreement management system registering predetermined agreement data from information about an agreement to a database, and allowing the data to be searched and inquired, comprising:
a unit assigning a management number for uniquely identifying individual agreement data, and registering the agreement data to the database;
a unit assigning a plurality of management numbers to one agreement, and registering the agreement;
a management number specifying unit specifying a management number; and
a unit searching for and outputting corresponding agreement data specified by said management number specifying unit, wherein
said management number specifying unit has a function for selecting some or all of a plurality of management numbers if the plurality of numbers are assigned to the one agreement, which is then registered.

21. The agreement management system according to claim 20, wherein
said unit assigning a plurality of management numbers and registering the agreement has a unit adding an additional number (subnumber) to a management number, and registering the agreement.

22. An agreement management system registering predetermined agreement data and balance data from information about an agreement to a database, and allowing the data to be searched and inquired, comprising:
a searching/outputting unit searching for data of a corresponding agreement by selecting a predetermined item among registered data of individual agreements, and outputting a search result as an agreement list by displaying or printing the result.

23. The agreement management system according to claim 22, wherein
said searching/outputting unit has a unit checking an access right of a user, and preventing the display or printing of some of the items of the agreement data from a displayed list of the agreement data which the user is not permitted to access.

24. The agreement management system according to claim 22, wherein
a result obtained from said searching/outputting unit is displayed or printed in a predetermined format as an agreement original.

25. The agreement management system according to claim 24, wherein
when the result is displayed or printed as the agreement original, a display enabling a selection of a range to be displayed or printed is made on a user terminal.

26. The agreement management system according to claim 24 or 25, wherein
said searching/outputting unit has a unit checking an access right of a user, and excluding part or a whole of an agreement original of agreement data, which is not permitted to be accessed, from a range to be printed.

27. The agreement management system according to claim 4, further comprising:
an adding/registering unit adding an additional number (version number) to a management number of agreement data if an additional arrangement by an addition or modification is made to agreement conditions, etc. of the registered agreement data, and registering the agreement data.

28. The agreement management system according to claim 27, wherein
said adding/registering unit makes an addition/modification based on the agreement data, and records and manages information differing from original agreement data.

29. The agreement management system according to claim 4, further comprising:
a registration screen switching unit registering a plurality of items of data by switching a screen depending on an agreement target and an agreement condition.

30. A database downloading processing device, comprising:
a unit separating each data registered to a database into a predetermined number of blocks, and assigning a corresponding item name to the each data in a predetermined arrangement; and
a unit outputting data corresponding to the item name in an order of the arrangement.

31. A database downloading method downloading data registered to a database, comprising:
separating each piece of data into a predetermined number of blocks, assigning a corresponding item name to each piece of data in a predetermined arrangement, outputting the data, and continuously outputting the data corresponding to the item name in an order of the arrangement.

32. The downloading method according to claim 31, wherein
the data registered to the database is arranged and output as a matrix, item names of the data are first output as an arrangement of a predetermined number of rows, and each piece of data is arranged and output in accordance with the arrangement.

33. An agreement management system, comprising:
for a process for an access right to access agreement information of the agreement management system,
an access right registering unit, and
an access right checking unit;
a selecting unit classifying a plurality of divisions into a plurality of division groups, and classifying agreement data and balance data of information about an agreement into predetermined group data, and permitting which division to access which group data; and
a selecting unit permitting an access to user data for each of the division groups, wherein
an access right is checked for each of the division groups and each of the agreement data groups.

34. The agreement management system according to claim 33, wherein
if a division to which a user belongs is the same as a division managing an agreement, an access is allowed to be made to agreement data, etc., which are handled by the division managing the agreement, separately from the access right.

35. The agreement management system according to claim 33, wherein
an access to balance data relevant to an agreement is permitted for a division having a right to manage the balance data of the agreement, separately from the access right.

36. The agreement management system according to claim 4, further comprising:
a unit extracting an agreement whose implementation report is to be made from individual registered agreements, and displaying the extracted agreement along with a report deadline.

37. The agreement management system according to claim 4, further comprising:
a unit displaying or printing a bill in a predetermined format based on data selected from among registered balance data.

38. An agreement database, which is a database for recording/storing information about an agreement, comprising:
in correspondence with one management number,
a storage area for recording basic information of an agreement;
a storage area for recording an agreement target in correspondence with an agreement parties relationship; and
a storage area for recording a consideration condition.

39. The database according to claim 38, further comprising:
a storage area for recording balance amounts such as a deposit, a running royalty, etc. along with calendar time information at which the balance data is incurred, in correspondence with the consideration condition of the management number.

40. The database according to claim 38, further comprising:
a storage area for recording data for distributing or sharing part of an income or an expenditure to a third party other than agreement parties, when the income or the expenditure occurs with one agreement.

41. The database according to claim 38, further comprising:
a storage area for recording information for distributing or sharing an income or an expenditure to a relevant division, when the income or the expenditure occurs with one agreement.

42. A computer-readable storage medium on which is recorded a program for causing a computer to execute:
a unit assigning a management number to basic information, an agreement target, an agreement condition, other relevant information, etc., which are regarded as data registration units, among information about an agreement, and registering the information;
a unit registering royalty balance information for each management number;
a searching unit searching an agreement list or agreement information with a predetermined condition; and
a display controlling unit displaying a search result.

43. A program for causing a computer to execute:
a unit assigning a management number to basic information, an agreement target, an agreement condition, other relevant information, etc., which are regarded as data registration units, among information about an agreement, and registering the information;
a unit registering royalty balance information for each management number;
a searching unit searching an agreement list or agreement information with a predetermined condition; and
a display controlling unit displaying a search result.

44. The agreement management system according to claim 33, wherein
an access to balance data relevant to an agreement at the time of registration is permitted for a division having a right to register the balance data of the agreement, separately from an access right to use the system.

45. The agreement management system according to claim 22, wherein
the agreement list display is made without being restricted by an access right.

46. The agreement management system according to claim 22, wherein
agreement data is stored by being separated into common data and individual data in a predetermined format, and the common data and the individual data can be combined and output.

47. A method, comprising:
registering at least basic information, an agreement target, and an agreement condition among information about an agreement;
registering a running royalty and balance information, which are relevant to the agreement;
performing an operation such as registration, modification, search, inquiry, display, or printing for data about an agreement recorded to an agreement database and a balance database.

48. A program for causing a computer to execute a method, the method comprising:
registering at least basic information, an agreement target, and an agreement condition among information about an agreement;
registering a running royalty and balance information, which are relevant to the agreement; and
performing an operation such as registration, modification, search, inquiry, display, or printing for data about an agreement recorded to an agreement database and a balance database.

49. A computer-readable storage medium on which is recorded a program for causing a computer to execute a method, the method comprising:
registering at least basic information, an agreement target, and an agreement condition among information about an agreement;
registering a running royalty and balance information, which are relevant to the agreement; and
performing an operation such as registration, modification, search, inquiry, display, or printing for data about an agreement recorded to an agreement database and a balance database.

50. The downloading method according to claim 30, wherein
the database handles agreement data, stores common data and individual data in a predetermined format by separating the common data and the individual data, and combines and outputs the common data and the individual data.
